(19) United States
(12) Patent Application Publication
(10) Pub. No.: US 2026/0320494 A1
(43) Pub. Date: Oct. 15, 2026

(54) SYSTEMS AND METHODS FOR ARTIFICIAL INTELLIGENCE BASED COMPATIBILITY MATCHING

(71) Applicant: Robert Beeman, Brookfield, CT (US)

(72) Inventor: Robert Beeman, Brookfield, CT (US)

(21) Appl. No.: 19/644,893

(22) Filed: Apr. 10, 2026

Related U.S. Application Data
(60) Provisional application No. 63/787,521, filed on Apr. 11, 2025.
(60) Provisional application No. 63/821,495, filed on Jun. 11, 2025.
(60) Provisional application No. 63/859,371, filed on Aug. 7, 2025.

(51) Int. Cl. G06N 20/00; G06F 18/21; G06F 18/22; G06F 21/62

(52) U.S. Cl. CPC G06N 20/00; G06F 18/217; G06F 18/22; G06F 21/6245

(57) ABSTRACT

Methods, systems, and apparatus for user compatibility identification. The system can be configured to receiving a first expressive user input from a first user of a plurality of users. The expressive user input includes at least one of natural language text, voice data, or behavioral interaction data. At least one processing device generates a first latent representation of the first user based on a machine learning model trained to receive expressive user inputs and generate corresponding latent representations. The processing device generates a set of compatibility scores based on a comparison of the first latent representation of the first user with latent representations of a set of users from the plurality of users. A second user from the set of users is identified on a user interface based on the compatibility score. An identity of the second user is provided to the first user.

### CROSS-REFERENCE TO RELATED APPLICATIONS

This non-provisional patent application claims the benefit of priority to U.S. Provisional Application No. 63/787,521, filed on Apr. 11, 2025, entitled “AI-DRIVEN HUMAN COMPATIBILITY PLATFORM UTILIZING DEEP LEARNING FOR DYNAMIC USER PROFILING AND ADAPTIVE CONNECTION MATCHING,” to U.S. Provisional Application No. 63/821,495, filed on Jun. 11, 2025, entitled “SYSTEM AND METHOD FOR PRIVACY-GOVERNED COMPATIBILITY MATCHING USING EVOLVING USER MODELS,” and to U.S. Provisional Application No. 63/859,371, filed Aug. 7, 2025, entitled “SYSTEM AND METHOD FOR DYNAMIC IDENTITY MODELING AND COMPATIBILITY MATCHING.” The contents of each of these applications are hereby incorporated by reference herein.

### TECHNICAL FIELD

This specification relates to computing systems, and more particularly to artificial intelligence based compatibility matching.

### BACKGROUND

Conventional systems for facilitating human compatibility matching often rely on static user profiles and predefined questionnaires. Digital platforms that facilitate interpersonal connection commonly rely on user-generated profiles and questionnaire-based data collection to model identity and surface compatibility. These systems typically prompt users to enter demographic data, personality traits, interests, and preferences into a structured profile format. Matching algorithms then compare this profile data across users to identify potential connections based on predefined compatibility rules. Some systems also employ psychological assessment frameworks, such as personality inventories or value-based scoring models, to compute compatibility scores. These approaches are widely used across online dating platforms, mentorship tools, and professional networking services.

Some platforms enhance profile-based systems with recommendation engines that analyze user behavior, such as swiping patterns, message frequency, or content engagement. Furthermore, many existing feedback and reputation systems, such as those used in consumer review platforms, professional directories, or service marketplaces, depend on public identity disclosure and fixed rating scales. Traditional group-based interaction platforms, such as forums, group chats, or online communities, tend to use interest-based segmentation and persistent membership structures.

### SUMMARY

A computer-implemented system for facilitating human compatibility matching can enable the dynamic generation of machine-learned user representations through the continuous analysis of multi-modal input, such as voice, text, and behavioral interaction data. The system can apply a machine learning model to the received multi-modal input to generate a dynamic representation of a user. Unlike systems that rely on static profiles, the representations evolve over time based on continuous user interaction. These dynamic representations can be used to assess compatibility between users based on expressive attributes such as emotional tone, communication style, and engagement patterns.

The system can further employ an intent overlay engine configured to dynamically adapt feature weightings of the latent user representation based on a declared or inferred context. By applying weighting parameters specific to an intent domain, the system can perform domain-conditioned compatibility computation, allowing users to seamlessly transition between different social interactions. Compatibility between users can be determined by comparing representations to generate compatibility metrics, which can be evaluated under a machine-enforced privacy state machine. This privacy state machine manages progressive identity reveal across legal, platform, and ephemeral states, ensuring that identity disclosure can be progressive and context dependent.

To maintain the accuracy of the dynamic representations, the system can utilize an expressive validation and calibration loop. The system can present generated reflective insights, referred to as mirror moments, to a user and adjust model confidence scores and decay parameters based on explicit or implicit user feedback. Furthermore, the system can manage ephemeral discussion threads that self-organize and auto-dissolve based on resonance scoring and engagement weight. This enables transient communication instances that automatically expire based on time decay or inactivity thresholds, supporting privacy and contextual relevance.

The described architecture provides several technical advantages. The closed-loop calibration engine can significantly reduce false-positive social matches by iteratively refining latent user representations based on continuous feedback. The machine-enforced privacy state machine can reduce unauthorized data exposure and data leakage risk by structurally enforcing identity state transitions at the architectural level. The intent overlay mechanism can reduce computational load and compute waste by applying intent-conditioned feature selection prior to comparison, allowing a single underlying model to serve multiple contexts without the need to re-collect or re-process raw data. The implementation of temporal decay parameters and automatic retirement of ephemeral threads can improve memory utilization and database optimization by preventing the indefinite accumulation of stale or unstructured text data.

A computer-implemented method, system, and non-transitory computer readable storage medium receive first expressive user input from a first user of a plurality of users. The first expressive user input includes at least one of natural language text, voice data, or behavioral interaction data. At least one processing device generates a first latent representation of the first user based on a machine learning model trained to receive expressive user inputs and generate latent representations associated with those inputs. The machine learning model receives the first expressive user input. This machine learning model is a multi-modal machine learning model.

The processing device generates a set of compatibility scores based on a comparison of the first latent representation of the first user with latent representations of a set of users from the plurality of users. The set of compatibility scores is generated based on vector similarity or graph distance between the first latent representation and latent representations of the set of users. A second user from the set of users is identified on a user interface based on the compatibility score associated with the first latent representation and a second latent representation of the second user. Next, an identity of the second user is provided to the first user.

The operations also involve determining a currently active state of the first user. Based on the currently active state, the processing device will cryptographically restrict access to an identity of the first user. The current active state of the first user is one of a verified legal identity state, a platform-assigned handle state, and an ephemeral context handle state. The currently active state transitions from the verified legal identity state to the platform assigned handle state based on user consent. Furthermore, the currently active state transitions from the ephemeral context handle state to the verified legal identity state based on at least one of a contextual change or a timeout. First user data is stored under a verified legal identity. A platform-assigned handle is generated, and at least one ephemeral context handle is generated for session-specific interactions.

Additionally, the processing device receives feedback from the first user on a presented interpretive reflection and updates the first latent representation based on the feedback. A current intent domain of the first user is determined, and compatibility scores are adjusted based on the current intent domain of the first user.

### BRIEF DESCRIPTION OF THE DRAWINGS

FIG. 1 illustrates a block diagram of a system-level architecture for an adaptive, Artificial Intelligence (AI)-driven human compatibility platform.

FIG. 2 illustrates a block diagram of an expressive data ingestion engine and a normalization pipeline configured to process multi-modal user input.

FIG. 3 details a dual-pathway architecture for modeling user identity.

FIG. 4 illustrates a block diagram of an expressive validation and calibration loop configured to maintain the accuracy of latent user representations.

FIG. 5 illustrates a state diagram of a privacy state machine configured to manage user identity and progressive reveal protocols.

FIG. 6 illustrates a block diagram of an intent overlay engine configured to dynamically adapt feature weightings of a latent user representation based on a declared or inferred context.

FIG. 7 illustrates a block diagram of a compatibility computation engine and a controlled surfacing/discovery layer configured to evaluate latent representations and output controlled compatibility results.

FIG. 8 illustrates a block diagram and graphical overlay of an ephemeral thread/resonance weighting lifecycle configured to manage transient discussions.

FIG. 9 illustrates a flowchart of an example process for compatibility identification, detailing the chronological execution of operations by at least one computing device.

FIG. 10 is a block diagram illustrating an example computer system.

Like reference numbers and designations in the various drawings indicate like elements.

### DETAILED DESCRIPTION

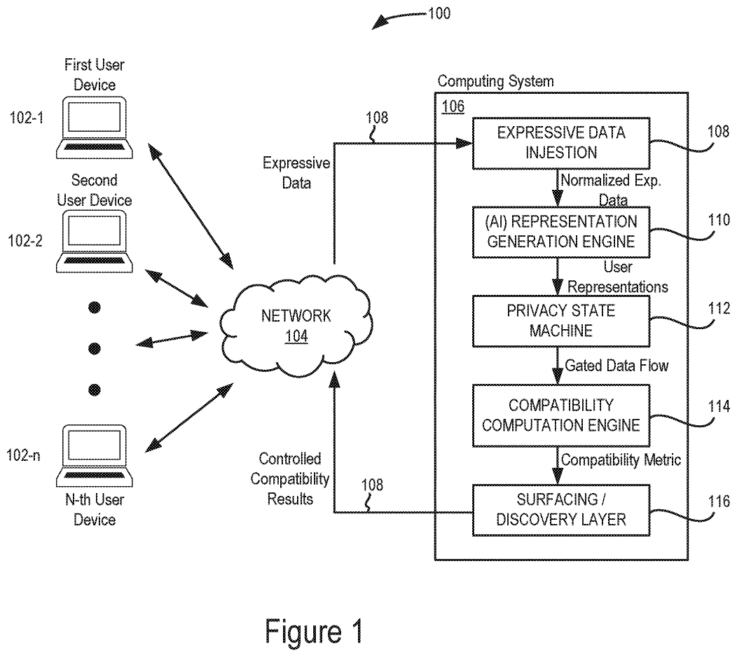

FIG. 1 illustrates a block diagram of a system-level architecture 100 for an adaptive, Artificial Intelligence (AI)-driven human compatibility platform. The architecture 100 illustrates a technical framework designed to facilitate dynamic personality modeling, multi-modal data processing, and privacy-governed interaction between participants.

A data path can begin at a first user device 102-1, a second user device 102-2,. and an n-th user device 102-n (collectively referred to as user devices 102), which capture data and transmit the data across a network 104. The data flows into a computing system 106, progressing sequentially through an expressive data ingestion 108, an AI representation generation engine 110, a privacy state machine 112, a compatibility computation engine 114, and a surfacing/discovery layer 116. As will be discussed in detail below, one or more operations in the sequential progression may not be performed. The order of processing data shown in FIG. 1 is only an example, and that the data processing may be performed in one or more different order of execution by the computing system 106.

Unlike traditional compatibility platforms that rely on static, checkbox-based profiles or fixed survey responses, FIG. 1 illustrates a dynamic architecture 100 configured to interpret unstructured, multi-modal expressive data. This architecture 100 can generate ephemeral, context-aware latent representations instead of relying on rigid attribute matching.

Within this architectural context, expressive data can incorporate information intentionally or passively communicated by a user that conveys an internal cognitive, emotional, or behavioral state. The expressive data can include typed or spoken natural-language text, audio recordings, vocal tone, prosody, facial or gestural cues, interaction timing, clickstream or selection patterns, editing behavior, or multimodal sensor data.

A latent representation can be a machine-generated encoding of the expressive data in a high-dimensional feature space that provides a basis for compatibility computation. The latent representation can incorporate structured schema indicators, vector embeddings, probabilistic state variables, symbolic rule graphs, or latent feature maps.

The computation pipeline executed by the computing system 106 can include the privacy state machine 112, which can be a computer-implemented policy engine enforcing transitions among discrete identity layers, structurally ensuring that identity disclosure can be progressive and strictly context-dependent.

The user devices 102 can incorporate mobile computing devices, desktop computers, or any network-enabled hardware capable of interacting with the platform. The user devices can incorporate input/output components such as microphones, touchscreens, or keyboards to capture user interactions locally. The user devices 102 can enable receiving a first expressive user input from a first user of a plurality of users, wherein the first expressive user input includes at least one of natural language text, voice data, or behavioral interaction data. The user devices can additionally receive controlled compatibility results routed back from the computing system 106 for display or interaction.

The network 104 can enable bidirectional data transmission between the user devices 102 and the computing system 106. The network 104 can be a wide area network, a local area network, a cellular network, or any combination of wired and wireless digital communication infrastructure configured to pass encrypted or unencrypted payloads.

The computing system 106 can be a server cluster, a distributed computing environment, or a hardware abstraction hosting the internal computational engines. The computing system 106 incorporates one or more physical processors and memory storing executable instructions to coordinate inter-module operations and pipeline execution.

The expressive data ingestion 108 can receive the raw expressive data from the network 104 and processes the data through a normalization pipeline. This normalization step can involve tasks such as tokenization, audio-to-text conversion, and sentiment feature extraction to create a unified expressive data buffer suitable for machine learning inference.

The AI representation generation engine 110 can process the normalized expressive data using machine learning models. The machine learning models can be deep learning architectures, such as recurrent neural networks or transformer-based language models, trained to evaluate sentiment polarity, empathy cues, and acoustic features simultaneously.

With respect to the machine learning models discussed above specifically in relation to the AI representation engine 110, and in general with respect to other machine learning models discussed herein, the machine learning models may not be limited to any single vendor-specific foundation model. In some examples, the machine learning models can be implemented one or more existing large language models and/or multi-modal machine learning models accessed via API (for example, transformer-based language models capable of processing natural language and, where applicable, audio-derived or behavioral feature inputs). The system discussed herein in general and machine learning models in particular can operate using commercially available third-party models, internally fine-tuned models, or a proprietary model. In some examples, the machine learning model may include one or more of the following: a transformer-based language model for natural language understanding and generation; an embedding model configured to convert user expressive inputs into vectorized semantic representations; a classification or scoring model configured to infer trait relevance, emotional tone, communication tendencies, intent cues, or compatibility-relevant signals; and, in some embodiments, a multi-modal model or ensemble architecture configured to incorporate text, voice-derived features, and behavioral interaction signals.

In some examples, the machine learning model can be trained and/or adapted using a combination of: publicly available pretraining corpora used in foundation model development; supervised fine-tuning datasets containing example user expressions and associated interpretive labels, trait indicators, or behavioral classifications; synthetic or human-reviewed prompt/response pairs designed to teach extraction of compatibility-relevant signal from unstructured user input; and platform-specific interaction data, such as user-entered free text, prompted responses, voice transcripts, engagement patterns, corrections, confirmations, rejections, or other feedback collected during operation of the system.

In some embodiments, training and refinement may include supervised learning, self-supervised learning, contrastive learning, reinforcement or preference-based optimization, retrieval-augmented processing, embedding alignment, and/or calibration based on explicit or implicit user feedback. In some examples, the system may be trained or configured to learn associations between expressive user input and downstream representational outputs, such as: latent user vectors, structured trait indicators, weighted feature maps, inferred communication or personality tendencies, and compatibility-relevant semantic representations.

The AI representation generation engine 110 can generate a first latent representation of the first user based on a machine learning model trained to receive expressive user inputs and generate latent representations associated with those inputs. The machine learning model can be, e.g., a multi-modal machine learning model.

The AI representation generation engine 110 can additionally receive feedback from the first user on a presented interpretive reflection. The AI representation generation engine 110 can enable updating the first latent representation based on the feedback. The machine learning models can be pre-trained on large datasets and fine-tuned on individual user interaction data.

The privacy state machine 112 can receive the generated user representations and can act as a cryptographic gating mechanism for downstream data flow. The privacy state machine 112 can dynamically determine visibility and data access rights based on a currently active identity state assigned to a specific user session. The privacy state machine 112 can enable determining a currently active state of the first user, and based on the currently active state, cryptographically restrict access to an identity of the first user. The currently active state of the first user can be one of a verified legal identity state, a platform-assigned handle state, and an ephemeral context handle state. The privacy state machine 112 can manage transitioning the currently active state from the verified legal identity state to the platform-assigned handle state based on user consent. The privacy state machine 112 can manage transitioning the currently active state from the ephemeral context handle state to the verified legal identity state based on at least one of a contextual change or a timeout. Furthermore, the computing system 106 can execute storing first user data under a verified legal identity. The computing system 106 can execute generating a platform-assigned handle. The computing system 106 can execute generating at least one ephemeral context handle for session-specific interactions.

The compatibility computation engine 114 can evaluate pairs or groups of latent representations allowed through the privacy state machine 112. The compatibility computation engine 114 can execute algorithmic comparisons to identify deep semantic resonance, interpersonal alignment, or shared intent domains without exposing the underlying raw data. The compatibility computation engine 114 can enable generating a set of compatibility scores based on a comparison of the first latent representation of the first user with latent representations of a set of users from the plurality of users. The set of compatibility scores can be generated based on, e.g., vector similarity or graph distance between the first latent representation and latent representations of the set of users.

The compatibility computation engine 114 also can enable determining a current intent domain of a user. The compatibility computation engine 114 can then enable adjusting the compatibility scores based on the current intent domain of the user. This allows the architecture to apply domain-specific weighting vectors that modulate feature importance.

The surfacing/discovery layer 116 can process the compatibility metrics to format and route actionable results. The surfacing/discovery layer 116 can execute routing decisions to pass data to user surfacing modules, group discovery modules, or activity recommendation modules. The surfacing/discovery layer 116 can enable identifying, on a user interface, a second user from the set of users based on the compatibility score associated with the first latent representation and a second latent representation of the second user. The surfacing/discovery layer 116 can then enable providing an identity of the second user to the first user, securely transmitting these controlled compatibility results back over the network 104.

In an illustrative example of the architecture 100 in operation, a first user can utilize the first user device 102-1 to submit a natural-language voice reflection. The expressive data ingestion 108 can receive and normalize the incoming voice data. The AI representation generation engine 110 can process the normalized audio using, e.g., a transformer model to generate a first latent representation that maps philosophical depth and emotional tone.

The privacy state machine 112 can cryptographically gate this latent representation under an ephemeral context handle to protect the first user's real identity. The compatibility computation engine 114 can apply e.g., a vector cosine similarity operation, comparing the first user's representation against a stored latent representation of a second user. Finding a high resonance, the surfacing/discovery layer 116 can route a controlled connection result to the first user device 102-1 and the second user device 102-2, providing an anonymous identity preview to both users.

This specific architecture can provide significant technical advantages, particularly regarding data security and system integrity. The machine-enforced privacy state machine 112 can improve data security by cryptographically restricting identity leaks at the architecture level, ensuring that transitions between legal, platform, and ephemeral states are governed by machine-executable policies rather than manual, error-prone user settings.

Furthermore, the AI representation generation engine 110 and the compatibility computation engine 114 can improve computational efficiency and memory utilization. By generating intent-conditioned latent representations, the computing system 106 can evaluate compatibility across multiple domains using the same underlying feature vector, avoiding continuous, memory-intensive re-processing and re-collection of raw user data for different interaction contexts.

Various implementations could be utilized to execute the described functionalities. For example, the AI representation generation engine 110 could utilize a localized edge-computing model directly on the first user device 102-1 rather than a centralized server model. This configuration can improve data privacy by retaining raw expressive data locally and can reduce network latency or network bandwidth demands.

As some examples, the compatibility computation engine 114 could utilize a lightweight cosine similarity on sparse vectors to execute rapid, single-pass filtering of a massive user pool. Following this initial filtering, the compatibility computation engine 114 could apply heavier neural attention alignment on the reduced dataset. This tiered approach can optimize the technical trade-off between computational speed during initial lookups and deep semantic accuracy during final compatibility scoring. While FIG. 1 provides a high-level depiction of the architecture 100, the following discussion provides additional functional and implementation details of the architecture 100.

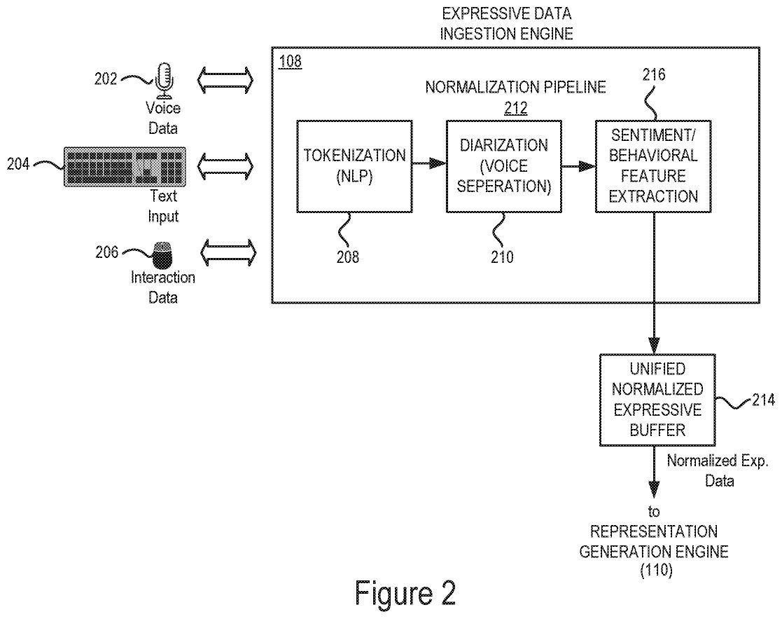

FIG. 2 illustrates a block diagram of an expressive data ingestion engine 108 and a normalization pipeline 212 configured to process multi-modal user input. The components and the process flow follow a logical sequence, starting with input hardware, routing through processing stages, and outputting synchronized data to a staging buffer.

FIG. 2 details the sub-operations to transform raw, unstructured human expression, such as voice, text, and clicks, into a standardized, multi-modal format. This ingestion and normalization step bridges the gap between chaotic human behavior and structured machine learning inference, ensuring downstream models receive clean, aligned data streams. Within this architectural context, expressive data incorporates any information intentionally or passively communicated by a user that conveys an internal state or preference. The expressive data can encompass typed or spoken natural-language text, vocal tone, prosody, interaction timing, clickstream sequences, and other multi-modal sensor inputs.

A microphone 202, a keyboard 204, and an interaction device 206, such as a mouse, capture the expressive data. The microphone 202, the keyboard 204, and the interaction device 206 can receive a first expressive user input from a first user of a plurality of users, wherein the first expressive user input includes at least one of natural language text, voice data, or behavioral interaction data.

The microphone 202 can capture voice data from the user. The captured voice data can be analyzed to extract acoustic features such as pitch, tone, pace, and inflection characteristics. The keyboard 204 can capture text input from the user. The captured text input incorporates natural-language text, syntax, sentence structure, and word choice, which can offer indicators of communication style. The interaction device 206 can capture passive behavioral interaction data. The interaction device 206 can record passive behavioral signals like response latency, scroll velocity, clickstream patterns, or interaction timing.

The expressive data ingestion engine 108 can function as the primary intake manifold for the multi-modal data. The expressive data ingestion engine 108 can process and route the inputs from the microphone 202, the keyboard 204, and the interaction device 206 into subsequent processing stages.

The normalization pipeline 212 can process the incoming data streams to the expressive data ingestion engine 108. The normalization pipeline 212 can align timestamps and formats across the different data types, standardizing the asynchronous inputs into a cohesive structure. A tokenization 208 engine can operate within the normalization pipeline 212. The tokenization 208 engine can chunk raw text into analyzable tokens for natural language processing, utilizing techniques such as named entity recognition, dependency parsing, or topic modeling.

A diarization 210 engine operates on the voice data within the normalization pipeline 212. The diarization 210 module partitions audio streams and assigns the audio segments to specific speakers, separating background noise from target user speech to isolate individual participants. A sentiment and behavioral feature extraction engine 216 further processes the normalized data within the normalization pipeline 212. The sentiment and behavioral feature extraction module extracts metadata, emotional valence, and paralinguistic features from the text, voice, and interaction streams. In some examples, the behavior feature extraction engine 216 can derive structured machine-readable attributes from one or more modalities associated with the user (e.g., text, voice and behavioral interaction data). As examples, the attributes extracted from a text input may include sentiment polarity or emotional valence (e.g., optimistic, negative, ambivalent), linguistic intensity, conversational depth, self-disclosure level, abstract vs. concrete reasoning tendency, humor or sarcasm indicators, directness vs. hedging, thematic or topic clusters, and references that may map to predefined traits or indicators in the platform schema. In some examples, the attributes extracted from audio-derived input may include speaking pace, pause frequency, pitch variation, vocal warmth or sharpness, prosodic emphasis, hesitation markers, emotional tone, interruption behavior, and other paralinguistic cues derivable from recorded speech or transcript-aligned audio features. In some examples, the attributes extracted from behavioral interaction data may include response latency, editing/revision behavior, dwell time, clickstream or tap sequence patterns, scroll behavior, prompt abandonment, selection hesitation, engagement duration, and consistency or inconsistency across repeated interactions.

In some examples, feature extraction can be performed using one or more of: natural language processing pipelines, acoustic signal processing, metadata extraction, classifier models, embedding-based inference, rule-based parsing, and/or prompt-guided large language model interpretation.

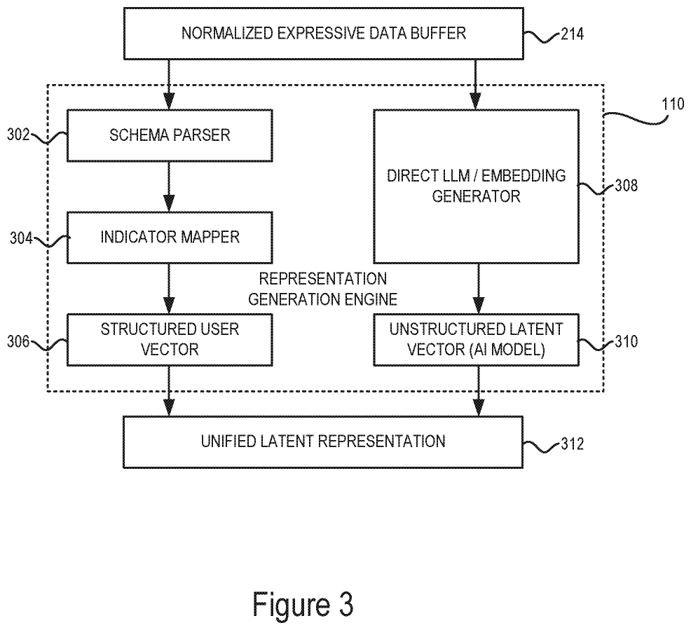

In schema-guided embodiments (e.g., as reflected in FIG. 3), the system can use a predefined internal personality/compatibility schema and instruct the model to evaluate user input against that schema in order to infer and assign relevance to specific indicators, traits, or other compatibility-relevant features. In other embodiments, the system may extract higher-dimensional latent features directly without requiring explicit human-readable labels at the extraction stage. In some examples, feature extraction can refer to the transformation of raw expressive input into structured or latent attributes that can be used downstream for representation generation, weighting, calibration, and compatibility analysis.

A unified normalized expressive buffer 214 receives the outputs from the normalization pipeline 212. The unified normalized expressive buffer 214 acts as a structured data staging area that holds the synchronized, normalized data before dispatching the data to downstream systems. A representation generation engine 110 (FIG. 1) receives the normalized expressive data from the unified normalized expressive buffer 214. The representation generation engine 110 can process the unified data to build or update latent user representations.

In some examples, a user verbally answers a prompt while simultaneously typing notes and moving the interaction device 206. The microphone 202 captures the voice data, the keyboard 204 captures the text input, and the interaction device 206 captures movement latency.

The normalization pipeline 212 uses the diarization 210 module to isolate the voice of the user, the tokenization 208 module to process the text, and the feature extraction module to identify hesitation in the behavioral data. All three streams are synchronized into the unified normalized expressive buffer 214.

Normalizing the multi-modal data, including voice, text, and behavior, into the unified normalized expressive buffer 214 provides significant technical advantages. This configuration can improve memory utilization and can reduce the processing latency of downstream machine learning models by providing pre-structured, aligned tensors rather than forcing the machine learning models to handle raw, asynchronous streams.

In some examples, the diarization 210 and the tokenization 208 steps could be executed on client-side hardware, such as edge processing on a mobile device, rather than on a centralized expressive data ingestion engine 108. This edge computing implementation carries distinct technical trade-offs. Performing the diarization 210 and the tokenization 208 on the client-side can improve data privacy and can reduce network bandwidth consumption.

In some examples, in relation to the expressive data ingestion engine 108, to process raw behavioral interaction data into compatibility-relevant signals, the expressive data ingestion engine 108 can route incoming signals from the interaction device 206 (or other equivalent device such as a headsup display, a game controller with movement sensors, etc.) through the normalization pipeline 212. Raw behavioral inputs, such as timestamped coordinate arrays of mouse movements, scroll velocity vectors, and clickstream sequences, can be first temporally aligned with concurrent text and voice streams. Within this synchronized pipeline, the tokenization engine 208 can process raw text strings into discrete natural language tokens, the diarization engine 210 can segment continuous audio streams into speaker-isolated acoustic features, and the sentiment/behavioral feature extraction engine 216 can concurrently ingest the aligned behavioral coordinate and timing arrays. By standardizing these asynchronous multimodal inputs against a common temporal baseline, the normalization pipeline 212 can ensure that a specific behavioral event—such as a localized cursor hesitation—is structurally mapped to the exact tokenized word or isolated voice utterance occurring at that exact moment, providing context for downstream evaluation.

Once temporally aligned, the sentiment/behavioral feature extraction engine 216 can execute specific algorithmic transformations to convert the raw hardware inputs into structured psychological or intent-based compatibility metrics. For example, the extraction engine 216 may route the time-series sequences of response latency and scroll velocity through a one-dimensional convolutional neural network (1D CNN) or a Long Short-Term Memory (LSTM) network configured to identify temporal interaction patterns. Additionally, the sentiment/behavioral feature extraction engine 216 may utilize defined heuristic mappings; if the engine 216 detects a high scroll velocity combined with a prompt abandonment rate exceeding a predefined threshold (e.g., dwelling on a text input block for less than three seconds before navigating away), the engine 216 may algorithmically map this raw data array to a structured machine-readable attribute, such as “high impulsivity” or “low conversational attention span.” These transformed behavioral attributes can then be output to the unified normalized expressive buffer 214 alongside the outputs from the tokenization engine 208 and the diarization engine 210, providing a fully contextualized, multi-dimensional tensor ready for the representation generation engine 110.

In some examples, in addition to implicit neural network inference, the sentiment and behavioral feature extraction engine 216 can be configured to execute a deterministic heuristic mapping module to process behavioral interaction data. While the tokenization 208 engine can process raw text into analyzable tokens and the diarization 210 module can isolate target user speech, the sentiment and behavioral feature extraction engine 216 can apply predefined, threshold-based heuristic rules to the passive behavioral signals captured by the interaction device 206. This heuristic fallback can ensure that raw hardware inputs—such as dwell time, typing cadence, and tap sequences—are reliably translated into structured, compatibility-relevant features even when downstream semantic inference is computationally expensive or ambiguous. For an illustrative heuristic mapping example, consider a scenario where a user responds to a system prompt. The sentiment and behavioral feature extraction engine 216 monitors the interaction timing and editing behavior. If the engine 216 detects a response latency exceeding a predefined temporal threshold (e.g., 8 seconds), combined with a high frequency of text revisions across the text boundaries defined by the tokenization 208 engine, a specific heuristic rule can be triggered. The feature extraction engine 216 can deterministically map this physical interaction pattern to a structured attribute, assigning a high relevance weight to an “analytical hesitation” or “high self-monitoring” trait. Conversely, if the feature extraction engine 216 measures a near-zero response latency with rapid, unrevised input, it can map this data to a “spontaneous” or “direct” communication tendency. By employing these explicit heuristic mappings, the system can output grounded, machine-readable attributes to the unified normalized expressive buffer 214, ensuring the representation generation engine 110 receives mathematically stable data structures for modeling user identity.

FIG. 3 illustrates a block diagram of a dual-embodiment representation generation engine 110 configured to convert data from a normalized expressive data buffer 214 into a unified latent representation 312. The representation generation engine 110 can process inputs to generate machine-readable profiles suitable for advanced compatibility modeling.

A process flow can proceed in a logical sequence, starting with an input from the normalized expressive data buffer 214. The input can enter the representation generation engine 110 and can split into two functionally equivalent pathways. A first track incorporates a schema parser 302, an indicator mapper 304, and a structured user vector 306. A second track incorporates a direct LLM/embedding generator 308 and an unstructured latent vector (AI model) 310. Both tracks can culminate in the unified latent representation 312.

FIG. 3 details a dual-pathway architecture for modeling user identity. In some examples, the system can utilize explicit schema-based parsing, implicit machine-learning model-inference pipelines, or a hybrid combination of both. This dual-embodiment configuration can differ from rigid architectures by allowing data to flow through multiple structurally distinct but functionally aligned processing tracks.

The first track and the second track can operate as functional equivalents designed to translate unstructured or chaotic human expressive input into a mathematical representation. This dual approach ensures that downstream compatibility engines can mathematically compare the outputs regardless of the specific generation pathway utilized.

The unified latent representation 312 can act as a dynamic psychological user model that evolves over time. A latent representation can be a machine-generated encoding of expressive data belonging to a user, mapped into a high-dimensional feature space that cannot be directly interpretable by humans.

The normalized expressive data buffer 214 can act as an intake point that provides synchronized text, voice, and behavioral features to the representation generation engine 110. The normalized expressive data buffer 214 can hold pre-processed, aligned data streams free of formatting discrepancies.

The representation generation engine 110 can act as a centralized processing environment hosting the dual pathways. The representation generation engine 110 can execute the structural transformations necessary to produce the unified latent representation 312.

The representation generation engine 110 can enable the limitation of generating a first latent representation of a first user based on a machine learning model trained to receive expressive user inputs and generate latent representations associated with those inputs. The representation generation engine 110 can receive the first expressive user input via the normalized expressive data buffer 214.

The schema parser 302 can execute rule-based or natural language processing-based parsing to extract explicit features from the incoming data. The schema parser 302 can map these extracted features against a predefined taxonomy or personality schema containing discrete domains, facets, or indicators. The schema parser 302 can be configured to interpret unstructured expressive user input against an internal structured interpretive schema so that the system can extract compatibility-relevant signal from otherwise noisy or ambiguous human expression.

In some examples, the schema parser 302 can receive normalized user input (e.g., text, transcript data, voice-derived features, behavioral signals, or combinations thereof) and evaluate that input for semantic, emotional, behavioral, contextual, and inferential meaning. Rather than merely identifying surface-level stated preferences, the schema parser 302 can be configured to infer deeper compatibility-relevant attributes that may underlie the user's expression.

For example, if a user states that they “exercise every day,” the schema parser 302 need not treat that statement as a single flat preference only. Instead, the schema parser 302 can evaluate surrounding context, phrasing, emphasis, associated language, behavioral history, or corroborating inputs to infer one or more possible underlying meanings, such as discipline orientation, aesthetic motivation, stress regulation, health optimization, self-image sensitivity, performance drive, or other compatibility-relevant signals.

In some examples, the schema parser 302 can operate by evaluating user input against a structured internal schema containing multiple levels of semantic categories and subcategories. In some examples, the schema parser 302 can assign one or more candidate mappings with associated confidence values rather than forcing a binary classification. The schema parser 302 can therefore produce probabilistic or weighted outputs reflecting varying levels of interpretive confidence. The schema parser 302 can be implemented using one or more of: prompt-guided large language model interpretation, natural language inference, semantic classification, embedding similarity, rule-based extraction, ontology-guided mapping, entity/intent detection, contextual weighting, or combinations thereof.

The schema parser 302 can output structured intermediate representations corresponding to inferred user characteristics, latent semantic tags, trait-relevant signals, confidence values, and/or candidate interpretive mappings, which can then be passed to the indicator mapper 304 and/or downstream representation generation components.

In some examples, the schema parser 302 can further support iterative refinement over time by incorporating additional user input, explicit user corrections, implicit behavioral validation, or accumulated interaction history to improve mapping confidence and reduce interpretive ambiguity. The schema parser 302 is not limited to a fixed or static ontology and may operate over an evolving internal schema that is refined over time based on system performance, user interaction data, or learned representational utility.

The indicator mapper 304 can receive the extracted features from the schema parser 302 and can assign normalized relevance weights to each trait. The normalized relevance weights can range from 0.0 to 1.0, and can be assigned based on emphasis, strength, and relevance detected in the input. The structured user vector 306 can represent the output of the left track. The structured user vector 306 can be formatted as a flat JSON-like object or a sparse vector stored in a fast-access data store.

The direct LLM/embedding generator 308 can operate as an alternative or parallel component that utilizes transformer models or neural networks. The direct LLM/embedding generator 308 can process the input from the normalized expressive data buffer 214 into high-dimensional feature spaces without relying on human-readable schema labels. The direct LLM/embedding generator 308 can directly process multiple modes of input concurrently. The “LLM” in the direct LLM/embedding generator 308 should be understood broadly as one or more large language models, embedding models, multi-modal encoder models, or ensembles thereof configured to process expressive user input directly into latent semantic representations without necessarily requiring explicit schema-based parsing at inference time.

In some examples, this direct model pathway, via the direct LLM/embedding generator 308, can be implemented using a pre-trained transformer-based language model or foundation model capable of processing natural language input, transcript-derived voice input, and/or other normalized expressive user data. In some examples, the model can additionally incorporate multi-modal encoders configured to ingest text, audio-derived features, behavioral metadata, or combinations thereof.

In some examples, the direct LLM/embedding generator 308 can be trained and/or adapted using one or more of: large-scale public or commercial pretraining corpora used in foundation model development; supervised fine-tuning data comprising expressive user inputs paired with interpretive, semantic, emotional, behavioral, or compatibility-relevant outputs; contrastive or embedding-alignment training data configured to bring semantically or compatibility-relevant user expressions closer in latent space and push non-resonant expressions farther apart; synthetic or human-reviewed prompt/response corpora designed to teach the model to extract deeper interpersonal or compatibility-relevant signal from unstructured user expression; and/or platform-specific interaction data, including user-entered responses, transcript data, behavioral interactions, user feedback, corrections, confirmations, rejections, and longitudinal engagement patterns.

In some examples, the direct LLM/embedding generator 308 can be further refined through self-supervised learning, supervised learning, contrastive learning, preference optimization, retrieval-augmented inference, reinforcement-based refinement, or feedback-based calibration. This pathway can allow the system to generate a dense latent semantic representation directly from expressive user input without the need for the extracted meaning to first be translated into explicit human-readable schema labels. For example, two users may each discuss a shared activity such as exercise, but the direct LLM/embedding generator 308 can infer materially different underlying motivations, priorities, emotional orientations, or interpersonal tendencies from the broader context of each user's expression, and encode those distinctions into the latent representation even where the literal subject matter appears superficially similar.

In some examples, to ensure robust and scalable generation of latent representations, the direct LLM/embedding generator 308 within the representation generation engine 110 can be implemented using a Two-Tower, or Siamese, neural network architecture. In this embodiment, the machine learning model can comprise two parallel, structurally identical sub-networks, or “towers,” which share the same underlying learned weights and parameters. During a matching operation, the first tower can receive the output from the normalized expressive data buffer associated with a first user, while the second tower simultaneously processes the normalized expressive data buffer output associated with a second user. Each tower utilizes a transformer-based encoder stack to process the multi-modal input—including the tokenized natural language text, diarized voice data, and extracted behavioral interaction data—and projects this data into a shared, high-dimensional continuous vector space.

The output of each respective tower is the unstructured latent vector 310, which acts as the machine-generated encoding of the user. To facilitate efficient downstream mathematical comparison by the compatibility computation engine 114, this latent vector is explicitly structured as a fixed-length, L2-normalized floating-point array, such as a 512-dimensional or 1024-dimensional dense vector. By projecting both users' expressive inputs through the shared weights of the Two-Tower architecture, the representation generation engine 110 can ensure that the resulting latent representations are mapped into the exact same dimensional space. This structural alignment may improve the reliability with which the the compatibility engine 708 executes vector operations, such as the vector cosine similarity 714 or Euclidean distance measurements, directly on the dense floating-point arrays without requiring computationally expensive, real-time cross-attention processing of the underlying raw text or audio data.

In some examples, to train and continuously refine the machine learning model hosted within the direct LLM/embedding generator 308, the computing system 106 can execute a training loop utilizing a contrastive learning objective, such as a Triplet Margin Loss function. During training, the calibration engine 412 can sample historical interaction data to form training triplets consisting of an anchor user representation, a positive user representation (e.g., a user with whom the anchor user had a successful interaction, high resonance score, or positive explicit feedback via the user verification interface 408), and a negative user representation (e.g., a user with whom the anchor user had an unsuccessful match or rapid session timeout). The training loop can mathematically adjust the underlying weights of the neural network to minimize the distance in the latent space between the anchor vector and the positive vector, while simultaneously maximizing the distance between the anchor vector and the negative vector by at least a predefined margin. By iteratively processing these triplets through the expressive validation and calibration loop 400, the machine learning model dynamically learns to project semantically and emotionally compatible users closer together in the high-dimensional feature space, thereby directly optimizing the generated unstructured latent vectors 310 for accurate downstream mathematical comparisons by the compatibility computation engine 114.

The direct LLM/embedding generator 308 can serve as an alternative or parallel embodiment to the schema-guided pathway, enabling compatibility computation based on direct semantic and relational inference from expressive user corpora, particularly in implementations where greater compute resources, larger user corpora, or higher-resolution embedding analysis are available. The direct LLM/embedding generator 308 is not limited to any particular vendor-specific model, dataset, or training stack, and may be implemented using commercially available third-party foundation models, internally adapted models, or proprietary in-house models. Both pathways in FIG. 3, schema-guided and direct LLM (AI model) are not only alternative embodiments, but can also be used in hybrid combination.

The unstructured latent vector (AI model) 310 can represent the output of the direct LLM/embedding generator 308. The unstructured latent vector (AI model) 310 can be a dense numeric embedding that abstracts the user input.

The unified latent representation 312 can receive data from the structured user vector 306, the unstructured latent vector (AI model) 310, or a combination thereof. The unified latent representation 312 can act as a standardized format bus, standardizing the outputs for downstream compatibility computation and privacy gating operations.

In some examples, the unified latent representation 312 can be multi-dimensional tensor or fixed-length floating-point array. For example, when generated via the direct LLM/embedding generator 308, the resulting unstructured latent vector (AI model) 310 can comprises a dense numeric embedding, such as a 512-dimensional or 1024-dimensional vector, where each discrete floating-point value numerically encodes an abstracted semantic, emotional, or behavioral feature extracted from the expressive data. Such a mathematical data structure can improve the compatibility computation engine's 114 execution of deterministic vector operations directly on the continuous feature space, providing a computationally efficient mechanism to quantify semantic resonance without relying on human-interpretable schema labels.

In some examples, a user inputs a phrase indicating they hate small talk but love philosophical debate. The normalized expressive data buffer 214 passes this text to the representation generation engine 110. Within the structured track, the schema parser 302 identifies the core concepts, and the indicator mapper 304 can calculate corresponding weights. The indicator mapper 304 can output a structured user vector 306 containing a data structure such as {“philosophical_depth”: 0.91, “small_talk_aversion”: 0.85}.

Simultaneously or alternatively, the direct LLM/embedding generator 308 can process the exact same text. The direct LLM/embedding generator 308 can produce an unstructured latent vector (AI model) 310, which can be e.g., a 512-dimensional numeric embedding capturing the abstract semantic characteristics of the input. Both tracks can feed their respective outputs into the unified latent representation 312.

The dual-embodiment architecture can provide distinct technical advantages. The first track incorporating the schema parser 302, the indicator mapper 304, and the structured user vector 306 can provide the technical advantage of high interpretability and lower computational overhead, which can improve computational performance during rapid filtering. The second track incorporating the direct LLM/embedding generator 308 and the unstructured latent vector (AI model) 310 can provide the technical advantage of capturing highly nuanced, emergent human signals that rigid, hardcoded schemas might miss, thereby improving the overall accuracy and depth of a resulting compatibility model.

In some examples, the representation generation engine 110 could be configured to dynamically toggle between the first track and the second track to conserve compute resources. For example, the computing system could execute only the schema parser 302 for initial, low-stakes interactions to improve power consumption and reduce latency. The computing system could then activate the direct LLM/embedding generator 308 only when deep, high-resolution resonance matching can be requested, thereby balancing heavy computational cost against semantic accuracy.

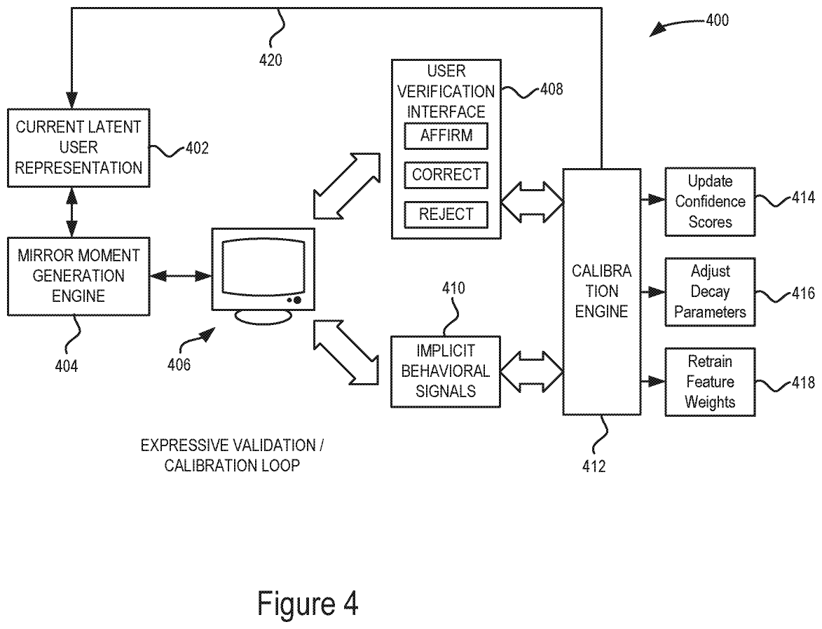

FIG. 4 illustrates a block diagram of an expressive validation and calibration loop 400 configured to maintain the accuracy of latent user representations. The expressive validation and calibration loop 400 can be a dynamic subsystem operating within a broader architecture to ensure psychological models remain current and accurate.

FIG. 4 details a closed-loop calibration architecture. Unlike conventional static profiles that become stale over time, this system tests its own artificial intelligence interpretations by generating contextual reflections and using the resulting user feedback to mathematically recalibrate the underlying data models. This closed-loop approach incorporates continuous validation to align a generated representation with a self-acknowledged identity of the user.

A current latent user representation 402 feeds into a mirror moment generation engine 404, which outputs a reflection to a display 406. Subsequently, two feedback intake paths, specifically a user verification interface 408 and implicit behavioral signals 410, feed into a calibration engine 412. The calibration engine 412 can execute outputs to update confidence scores 414, adjust decay parameters 416, and retrain feature weights 418. The process ultimately completes the loop via a feedback pathway 420 routing back to the current latent user representation 402.

The current latent user representation 402 can be a dynamic, multi-dimensional array or embedding. The current latent user representation 402 can model the current inferred psychological state, intent, and traits of the user. This representation may serve as the baseline data structure for downstream matching operations.

The mirror moment generation engine 404 can receive the data from the current latent user representation 402. The mirror moment generation engine 404 can use a large language model to generate an interpretive reflection, also known as a “Mirror Moment”. The mirror moment generation engine 404 can produce narrative, natural-language reflections of the user's traits applying different resonance tiers, such as superficial, intermediate, or deep dive tiers, based on privacy and intensity settings.

The display 406 receives the generated narrative from the mirror moment generation engine 404. The display 406 can be a hardware user interface component, such as a mobile device screen or monitor, rendering the reflection for the user to view. Following the presentation on the display 406, the user verification interface 408 can capture explicit feedback. The user verification interface 408 can incorporate explicit feedback mechanisms, such as Affirm, Correct, and Reject buttons or text inputs, that capture the direct validation of the mirror moment by the user.

Concurrently, the implicit behavioral signals 410 provide a second layer of validation. The implicit behavioral signals 410 incorporate passive tracking mechanisms, such as measuring response latency, semantic agreement in chat sessions, or engagement duration, which can be used as supplementary validation data without requiring active user input. The calibration engine 412 can receive inputs from both the user verification interface 408 and the implicit behavioral signals 410. The calibration engine 412 can aggregate explicit and implicit signals to calculate necessary model adjustments.

The calibration engine 412 can execute an operation to update confidence scores 414. This operation involves the mathematical boosting or lowering of probability weights assigned to specific personality traits based on the validation signals received. The calibration engine 412 can also execute an operation to adjust decay parameters 416. This operation incorporates a State-Based Temporal Readjustment Model that applies temporal decay functions, such as an exponential decay, where traits lose influence over time unless reaffirmed. Furthermore, the calibration engine 412 can execute an operation to retrain feature weights 418. When the calibration engine 412 detects persistent corrections or recurring contradictions, the retrain feature weights 418 operation triggers the re-weighting or fine-tuning of the underlying machine learning feature vectors to prevent ongoing interpretive errors. The feedback pathway 420 transmits the calculated updates back to the beginning of the architecture 100. The feedback pathway 420 provides the cyclical closure of the loop, overwriting or updating the baseline data within the current latent user representation 402.

In some examples, the mirror moment generation engine 404 can present an interpretive reflection on the display 406 stating, “You seem to rely heavily on sarcastic humor when discussing stressful topics.” The user may interact with the user verification interface 408 to hit an “Affirm” button. The calibration engine 412 can receive this explicit signal and execute an operation to update confidence scores 414, raising the relevance weight of a sarcastic humor trait from 0.60 to 0.85, which then updates the current latent user representation 402 via the feedback pathway 420.

This configuration provides distinct technical advantages. The closed-loop architecture of the calibration engine 412 provides the technical advantage of significantly reducing false-positive social matches by continuously verifying internal assumptions. Furthermore, the execution of the adjust decay parameters 416 operation improves memory utilization and processing efficiency by algorithmically deprecating stale or obsolete data, ensuring the system does not waste computational resources evaluating and matching users based on outdated psychological states.

In some examples, the adjust decay parameters 416 operation could utilize a simple stepwise drop, such as dropping trait relevance to zero after a predefined number of days of inactivity, instead of calculating a continuous exponential decay curve. This alternative can improve computational simplicity and reduce continuous background processing overhead.

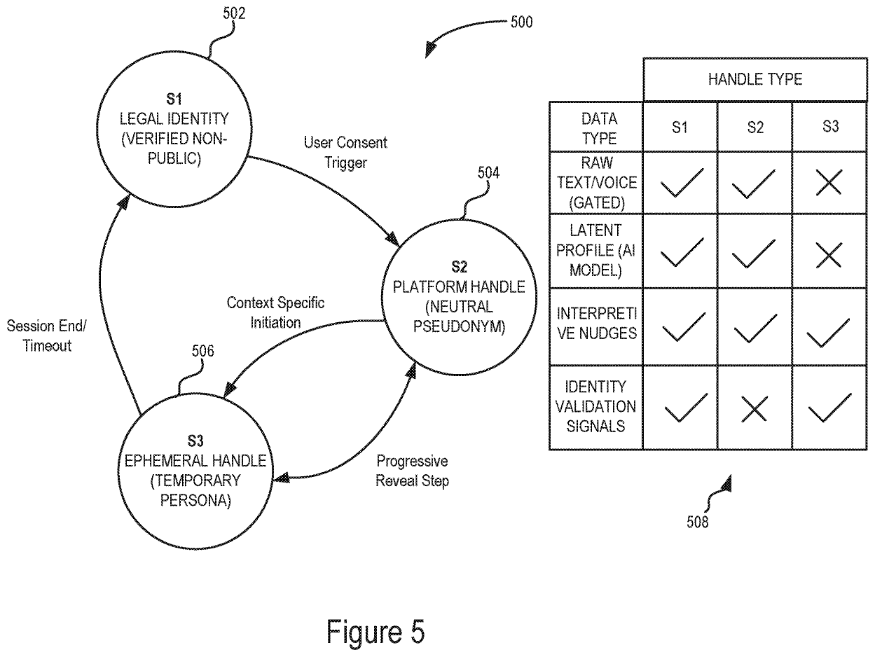

FIG. 5 illustrates a state diagram of a privacy state machine 500 configured to manage user identity and progressive reveal protocols. The privacy state machine 500 acts as an overarching policy engine that structurally enforces privacy through dynamic state transitions. Unlike traditional social platforms that rely on manual user privacy checkboxes or static global profiles, the state machine in FIG. 5 dictates that identity can be treated as a layered, progressive reveal mechanism.

Data visibility, which includes raw text, latent profiles, interpretive nudges, and identity validation signals, can be strictly gated depending on which node a session currently occupies. The privacy state machine 500 can incorporate three core nodes: a legal identity state 502, a platform handle state 504, and an ephemeral handle state 506. The legal identity state 502 can be a verified, non-public base layer. The legal identity state 502 can be utilized for regulatory compliance and trust and safety auditing. By utilizing the legal identity state 502, the privacy state machine 500 can enable storing user data under a verified legal identity.

The platform handle state 504 can be a permanent, anonymized pseudonym, such as an auto-generated alphanumeric string. The platform handle state 504 can be utilized for message routing and scaffold building after a mutual connection occurs. The ephemeral handle state 506 can be a context-specific, temporary persona created on-the-fly for specific chats or domains. The ephemeral handle state 506 disappears unless a connection deepens. The deployment of the ephemeral handle state 506 can enable generating at least one ephemeral context handle for session-specific interaction.

Directed edges between the nodes represent logical triggers that initiate state transitions. The privacy state machine 500 can enable enforcing transitions among states via a machine-executable policy engine. A user consent trigger can move a user from the legal identity state 502 to the platform handle state 504 when explicit authorization can be granted. A context-specific initiation trigger can spawn the ephemeral handle state 506 from the platform handle state 504 when entering a new, isolated interaction domain. A progressive reveal step trigger can escalate the ephemeral handle state 506 to the platform handle state 504 based on mutual resonance. Conversely, a session end/timeout trigger automatically switches the state to the legal identity state 502 or the platform handle state 504, dissolving the temporary persona.

An access-control table 508 can be a matrix that maps the handle types, which include the legal identity state 502, the platform handle state 504, and the ephemeral handle state 506, to specific data types. These data types can include raw text/voice, a latent profile, interpretive nudges, and identity validation signals. While four data types are depicted in FIG. 5, fewer or additional data types may be used. The access-control table 508 dictates that certain states lack access to specific data layers. For example, the ephemeral handle state 506 cannot access the raw text/voice or the latent profile to ensure complete anonymity during initial encounters. By enforcing the access-control table 508, the privacy state machine 500 can enable controlling visibility of representations based on active handle state.

In some examples, a user may enter an anonymous group discussion. The privacy state machine 500 invokes the ephemeral handle state 506. During the chat, the user resonates with another participant. Based on mutual engagement, the progressive reveal step trigger fires, transitioning their connection state to the platform handle state 504. If the chat can be abandoned, the session end/timeout trigger automatically dissolves the ephemeral handle state 506, leaving no permanent public trace.

The privacy state machine 500 can utilize dynamic cryptographic key management to restrict data access based on the currently active state. When a context-specific initiation trigger transitions a user into the ephemeral handle state 506, the privacy state machine 500 can generate a temporary cryptographic key pair specifically tied to that session. The public key can be used to encrypt the interaction data, while the corresponding private key can be held strictly in volatile memory associated with the ephemeral context handle. Upon a session end/timeout trigger, the computing system flushes the volatile memory, permanently destroying the private key. This operation cryptographically severs the connection between the user and the interaction, rendering the data unrecoverable and technically ensuring that the ephemeral handle state 506 disappears without leaving a permanent, traceable record.

Conversely, user data stored under the legal identity state 502 can be encrypted at rest using persistent, high-grade symmetric encryption standards, such as AES-256. When a user consent trigger moves the active session from the legal identity state 502 to the platform handle state 504, the privacy state machine 500 may not simply flip a software permission flag; rather, it may also issue a distinct, restricted cryptographic token or a separate access key mapped to the anonymized pseudonym. This mechanism can ensure that downstream processing components, such as the compatibility computation engine 114, can perform operations on latent representations tied to the platform handle state 504 without possessing the cryptographic keys required to decrypt or access the underlying verified legal identity. Furthermore, data in transit across the network 104 can be secured via transport layer security protocols, such as TLS 1.3, maintaining end-to-end cryptographic integrity across the progressive reveal transitions within the access-control table 508.

The privacy state machine 500 provides the technical advantage of improving data security by structurally separating personally identifiable data from public interaction data. This can be achieved via distinct encryption keys or access-control lists for each state, preventing data leakage at the architectural level. Furthermore, omitting a global search index for handles can improve memory utilization and reduce the processing load on a database engine. Since users cannot query the entire database for the platform handle state 504 or the ephemeral handle state 506, a computing system avoids heavy, synchronous search queries.

In some examples, the privacy state machine 500 could utilize a decentralized, blockchain-based decentralized identity framework rather than a centralized access-control table 508. This blockchain-based alternative can improve cryptographic verification and user data sovereignty.

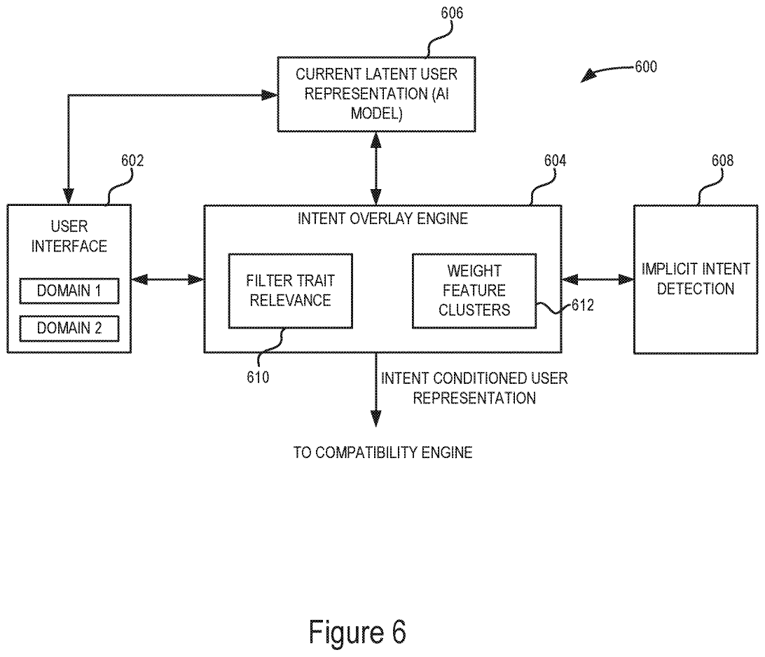

FIG. 6 illustrates a block diagram of an intent overlay engine 604 configured to dynamically adapt feature weightings of a latent user representation based on a declared or inferred context. The architecture illustrates an integration of user inputs and computational modules to provide contextual relevance to machine learning representations. A user interface 602, showing a Domain 1 and a Domain 2, and an implicit intent detection 608 feed inputs into the intent overlay engine 604. These inputs enter alongside a current latent user representation 606. Inside the intent overlay engine 604, sub-operations include a filter trait relevance 610 and a weight feature clusters 612. The final output, an intent conditioned user representation, routes to a compatibility engine.

FIG. 6 details an architecture for domain-conditioned computation. Unlike traditional systems requiring users to manually build entirely separate profiles for different contexts, such as dating versus professional networking, this system dynamically re-weights a single, core latent representation on the fly. This architecture provides significant adaptability. An intent domain can be viewed as a contextual mode outlining the purpose or social context under which compatibility can be computed. Examples of an intent domain can include romantic, platonic, academic, professional, and self-reflective contexts.

The user interface 602 can receives an explicit indication of a current intent domain of a user. The user interface 602 can capture selections such as the Domain 1 or the Domain 2, directly reflecting the stated purpose of the user for a given session. Concurrently or alternatively, the implicit intent detection 608 infers intent contextually. The implicit intent detection 608 analyzes interaction patterns, prompt selection history, or communication tone without requiring explicit user selection. As described, the user interface 602 and the implicit intent detection 608 can contribute to determining a current intent domain of a first user.

The current latent user representation 606 acts as the base machine-generated encoding of the user derived from expressive data. For example, the latent user representation 606 can be generated by the representation generation engine 110 (FIG. 1). The current latent user representation 606 can include a comprehensive, multi-dimensional mapping of traits and behavioral indicators prior to any contextual filtering.

The intent overlay engine 604 can function as the core processing module that can adapt the current latent user representation 606 to the user intent. The intent overlay engine 604 can apply a set of weighting parameters specific to the intent domain to the latent user representation 606.

Within the intent overlay engine 604, the filter trait relevance 610 sub-module modulates feature importance. The filter trait relevance 610 can zero out or ignore traits that can be deemed irrelevant to the active intent domain, pruning the dataset to only the most applicable signals.

The “traits” referenced here can be determined upstream of the intent overlay engine, primarily through the representation generation process (e.g., as described in FIG. 3). In particular, traits can be inferred from expressive user input via schema-guided parsing, direct model inference, or a hybrid combination of both. These traits represent compatibility-relevant semantic, behavioral, emotional, or contextual signals extracted from user expression.

In some examples, traits can be associated with structured labels within an internal interpretive schema (e.g., categories, subcategories, or other organizational constructs), which can allow the system to normalize, compare, and weight signals across users. In some examples, traits may exist as latent or embedding-based features without requiring fully human-readable labels at all stages. The inferred traits can be included in the latent user representation. The latent representation can be a composite data structure that encodes both structured trait signals (e.g., labeled or semi-labeled features with associated weights or confidence values), and/or unstructured or high-dimensional embedding vectors capturing semantic and contextual meaning.

In some examples, the latent user representation may include elements such as trait identifiers or semantic feature references (structured or latent), associated weights or relevance scores, confidence values reflecting inference certainty, temporal decay or recency modifiers, contextual tags or domain associations, and/or embedding vectors representing higher-dimensional semantic encoding.

In some examples, a latent representation may be expressed conceptually as a structured data object containing entries such as: a set of inferred feature signals (e.g., trait-like attributes or semantic tags), a corresponding weight or strength value for each signal, a confidence score for each inference, and optional metadata such as timestamp, recency weighting, or domain relevance indicators.

The intent overlay engine 604 can dynamically filter and re-weight the existing latent representation based on a current intent domain (e.g., romantic, social, professional, or self-reflective). This allows the computing system 106 to emphasize traits relevant to the active context while suppressing or de-emphasizing traits that are less relevant for that specific interaction mode. For example, a latent representation may contain signals related to communication style, emotional expression, motivation, conflict resolution tendencies, and other inferred characteristics. When operating in a romantic context, the system may assign higher weight to emotional availability, vulnerability, or relational preferences, whereas in a professional or activity-based context, the system may instead prioritize traits such as discipline, goal orientation, or collaboration style. The latent representation can function as a persistent, multi-dimensional model of the user, while the intent overlay engine 604 can provide context-specific projection of that model for downstream compatibility computation.

Furthermore, the weight feature clusters 612 sub-module applies domain-specific weighting vectors or matrices. The weight feature clusters 612 can amplify the importance of specific behavioral or emotional clusters that align heavily with the current intent domain.

Cluster can refer to groupings of related compatibility-relevant features, traits, inferred signals, or semantic dimensions that can be weighted together for a given intent domain. In some examples, the cluster can correspond to a set of related user characteristics that tend to function together in a particular context. For example, in a romantic context, a cluster might include features relating to emotional openness, conflict handling, intimacy preferences, attachment tendencies, or communication style. In an academic or study-oriented context, a cluster might instead include features relating to learning style, cognitive pacing, structure preference, collaboration style, or time-of-day productivity. Accordingly, the weight feature clusters operation 612 can assign increased or decreased importance to grouped sets of relevant signals within the latent representation depending on the currently active intent domain.

In some embodiments, such clusters can be predefined by the platform as part of an internal interpretive schema or weighting framework; inferred dynamically by a machine learning model based on semantic similarity, contextual co-occurrence, or learned relevance patterns; or implemented as a hybrid combination of predefined and dynamically inferred groupings.

In some examples, a “cluster” can have a flexible taxonomy and can broadly refer to any machine-usable grouping of compatibility-relevant features that allows the system to contextually emphasize or suppress portions of a user's latent representation for downstream matching. The weight feature clusters 612 sub-module can apply domain-specific weighting to grouped sets of related semantic, behavioral, emotional, or compatibility-relevant features within the latent representation, thereby increasing or decreasing the influence of those grouped signals depending on the currently active intent domain.

The intent conditioned user representation represents the output of the intent overlay engine 604. This output can be a dynamically adjusted feature space that can be sent downstream to the compatibility computation engine 114 for precise, context-aware matching. The operations of the intent overlay engine 604, culminating in the intent conditioned user representation, can enable adjusting compatibility scores based on the current intent domain of the first user.

In some examples, a user may switch their focus from seeking a study partner, which represents an academic domain, to dating, which represents a romantic domain. The user may indicates this shift via the user interface 602. Following this shift, the intent overlay engine 604 can receive the current latent user representation 606. The intent overlay engine 604 utilizes the filter trait relevance 610 operation to minimize or zero out academic study habits. Next, the intent overlay engine 604 applies the weight feature clusters 612 operation to amplify emotional availability and relationship goals. The resulting intent conditioned user representation can then be sent to the compatibility computation engine 114 for relevant matching.

The intent overlay engine 604 provides the technical advantage of significantly reducing computational load and compute waste. By applying intent-conditioned feature selection prior to comparison, the system can serve multiple contexts without forcing the memory-intensive re-collection and re-processing of expressive data to build new user models from scratch. In some examples, the weight feature clusters 612 operation could utilize a static, pre-defined lookup table of scalar multipliers for different domains rather than a dynamically learned attention mechanism. Utilizing static multipliers can improve processing speed and reduce latency during context switching.

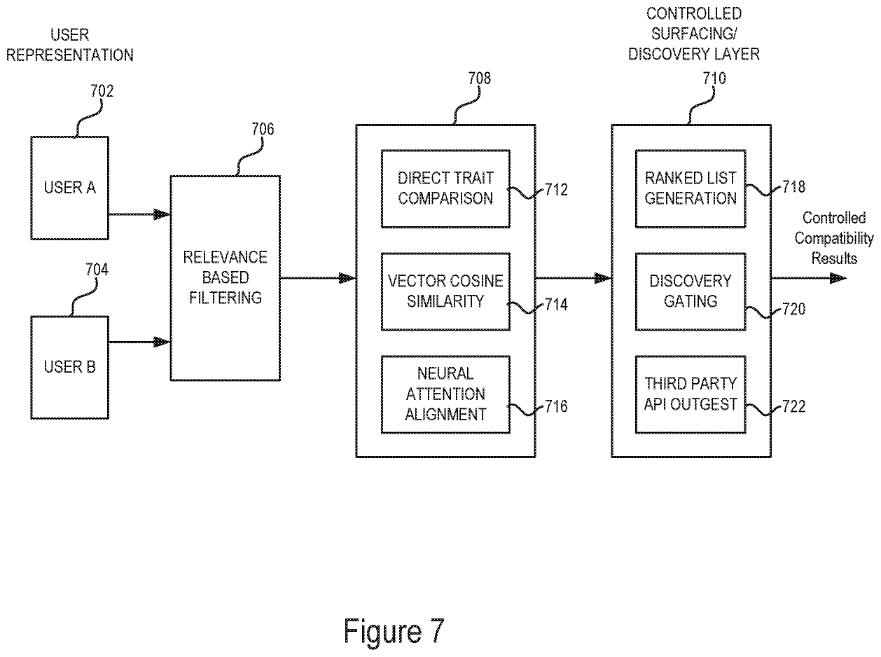

FIG. 7 illustrates a block diagram of a compatibility computation engine 708 and a controlled surfacing/discovery layer 710 configured to evaluate latent representations and output controlled compatibility results. A data path can begin with input vectors, specifically a user representation 702 associated with User A, and a user representation 704 associated with User B. These vectors flow into a relevance based filtering 706. The data then proceeds to the compatibility engine 708, and finally routes to the controlled surfacing/discovery layer 710 to produce controlled compatibility results.

FIG. 7 details the core interpretive matching architecture. Unlike legacy systems that rely on static, rule-based attribute matching, such as matching location or age checkboxes, this system mathematically compares dynamically evolving, multi-dimensional latent feature vectors to identify semantic resonance and emotional alignment.

The controlled surfacing/discovery layer 710 operates under strict privacy controls, ensuring matches are surfaced contextually. Within this context, a compatibility metric can be defined as a scalar, vector, or categorical value representing the degree of resonance or similarity between representations. The user representation 702 and the user representation 704 can be multi-dimensional latent vectors generated by prior machine learning models. These representations act as a machine-generated encoding of user expressive data in a high-dimensional feature space not directly interpretable by humans.

The interactions between the user representations 702, 704 and the compatibility engine 708 can generate a set of compatibility scores based on a comparison of a first latent representation of a first user with latent representations of a set of users. The relevance based filtering 706 receives the incoming user representation 702 and the user representation 704. The relevance based filtering 706 acts as an initial, high-speed pruning mechanism to remove non-viable candidates based on hard boundaries or domain mismatch before expensive neural computation occurs.

The compatibility engine 708 receives the filtered vectors from the relevance based filtering 706. The compatibility engine 708 acts as the primary processing module that evaluates semantic resonance between the representations to generate algorithmic compatibility metrics. Inside the compatibility engine 708, a direct trait comparison 712 executes initial processing. The direct trait comparison 712 evaluates specific, mapped indicators or schema buckets for direct overlap between the user representation 702 and the user representation 704. A vector cosine similarity 714 further evaluates the representations. The vector cosine similarity 714 can execute mathematical operations to find the cosine of the angle between two multi-dimensional vectors, determining their orientation similarity in the latent space. By employing this mathematical evaluation, the vector cosine similarity 714, the set of compatibility scores can be generated based on vector similarity or graph distance. A neural attention alignment 716 provides deep semantic evaluation. The neural attention alignment 716 can be an advanced neural network technique, such as utilizing cross-attention mechanisms, that evaluates contextual alignment and deeper emotional resonance between complex embeddings.

When evaluating latent representations using vector similarity, the compatibility computation engine 114 can apply a vector cosine similarity 714 operation to the generated feature vectors. Specifically, the computing system 106 can receive a first user representation 702 and a second user representation 704, both mapped as multi-dimensional latent vectors within a high-dimensional feature space. To determine the degree of alignment, the vector cosine similarity 714 module can execute a mathematical operation to calculate the cosine of the angle between these two numeric embeddings. This calculation evaluates the orientational similarity of the vectors in the latent space; a narrower angle yielding a higher cosine value mathematically indicates a strong degree of semantic resonance and emotional alignment between the respective users, independent of the vectors'magnitude. The compatibility engine 708 can utilize this calculated scalar value as the basis for the generated compatibility score, which is subsequently output to the controlled surfacing/discovery layer 710 to facilitate the ranked list generation 718 and privacy-gated candidate identification. In some examples the magnitudes of the vectors can be considered as well, such as in instances where the degree of resonance is determined based on intensity, confidence, or extremity of a trait. As an example, Euclidean or Manhattan distance measurements can indeed take into account the magnitudes of the vectors.

As mentioned above, in addition to or as an alternative to calculating vector similarity, the compatibility computation engine 114 can evaluate latent representations by computing a graph distance. To execute this computation, the computing system 106 can model the latent representations of the plurality of users as interconnected nodes within a relational graph data structure. Edges between these nodes represent shared behavioral indicators, mapped explicit traits, or semantic alignments extracted from the expressive data. The compatibility computation engine 114 can determine the graph distance between a first node corresponding to the first latent representation of the first user and a second node corresponding to a second latent representation of a second user by applying a mathematical graph traversal or structural similarity algorithm, such as a shortest-path calculation, Personalized PageRank, or Jaccard similarity of their shared connected node sets. A shorter calculated graph distance or a higher structural overlap can mathematically correlate to a stronger semantic resonance, which the compatibility engine 708 can then output as the generated compatibility score for use by the controlled surfacing/discovery layer 710.

The controlled surfacing/discovery layer 710 receives raw mathematical metrics from the compatibility engine 708. The controlled surfacing/discovery layer 710 translates the raw mathematical metrics into actionable, privacy-gated system outputs. The controlled surfacing/discovery layer 710 can enable identifying a second user based on the compatibility score, and providing an identity of the second user to the first user. Inside the controlled surfacing/discovery layer 710, a ranked list generation 718 ranks candidates based on the composite compatibility metric. Concurrently, a discovery gating 720 enforces progressive reveal protocols, suppressing or allowing identity information based on mutual engagement states and privacy settings. A third party API outgest 722 can interact with external hardware or software. The third party API outgest 722 can enable compatibility-as-a-service, securely transmitting de-identified resonance data to external systems or client applications.

In an example scenario, the user representation 702 associated with User A and the user representation 704 associated with User B can enter the pipeline. The relevance based filtering 706 confirms they share the same intent domain. The compatibility engine 708 utilizes the vector cosine similarity 714 to compare their traits, resulting in a high score. The controlled surfacing/discovery layer 710 executes the ranked list generation 718, placing User B at the top, and utilizes the discovery gating 720 to provide an anonymous, ephemeral identity of User B to User A.

The sequential structure of this architecture provides significant technical advantages. For example, executing the relevance based filtering 706 prior to executing the neural attention alignment 716 reduces compute waste and improves latency by sparing processor cycles that would otherwise be spent executing heavy tensor operations on fundamentally mismatched vectors. In some examples, the vector cosine similarity 714 operation could alternatively utilize Euclidean distance or Manhattan distance measurements. This approach can provide a stricter magnitude-based comparison for localized clusters.

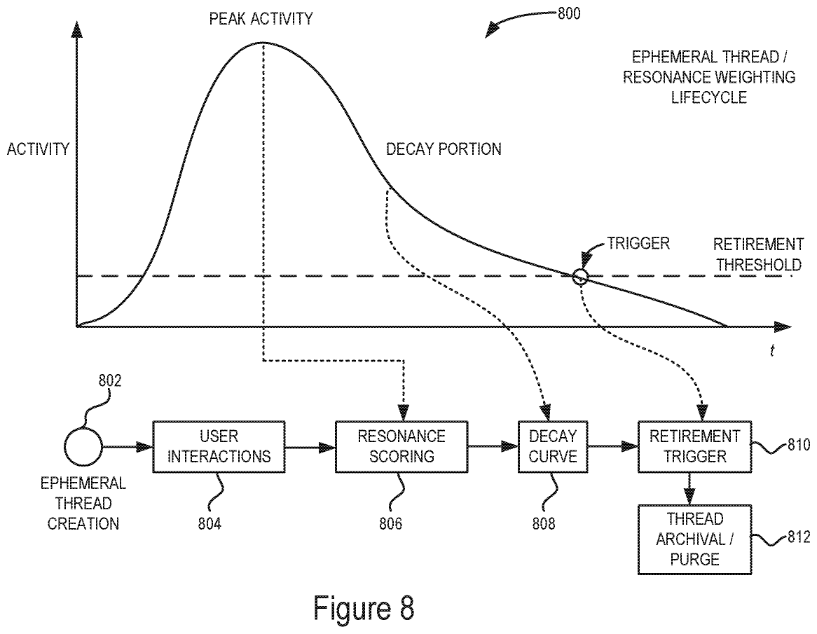

FIG. 8 illustrates a block diagram and graphical overlay of an ephemeral thread/resonance weighting lifecycle 800 configured to manage transient discussions. The ephemeral thread/resonance weighting lifecycle 800 can provide a framework for creating, scoring, and automatically retiring digital communication spaces based on user engagement.

The components and the process flow can proceed in a logical sequence mapped against a graphical overlay charting an activity metric against time. The graphical overlay incorporates a peak activity point, a decay portion, and a retirement threshold. Corresponding to this temporal graph, the process sequentially flows through an ephemeral thread creation 802, user interactions 804, a resonance scoring 806, a decay curve 808, a retirement trigger 810, and a thread archival/purge 812.

FIG. 8 depicts a system configured for managing ephemeral digital environments. Unlike traditional platforms with permanent chat histories, such as standard forums or persistent messaging applications, this system treats digital meeting places as temporary, auto-dissolving spaces. This architecture can mirror real-world, transient social mingling where conversations naturally form, peak, and fade away based on active engagement.

The lifespan of a thread can be determined by actual semantic resonance and engagement, rather than just a strict, arbitrary time limit. Resonance weighting can be a quantitative measure of interaction quality calculated from engagement frequency, reciprocity, emotional tone, or semantic alignment. To maintain privacy within these transient spaces, users can utilize an ephemeral context handle (e.g., as shown in FIG. 5). The ephemeral context handle can be a temporary persona created on-the-fly for a specific session or domain, which can disappear unless mutual resonance prompts a deeper connection.

Regarding the graphical overlay, the activity metric can be a composite value calculated from interaction frequency, positive sentiment markers, and overall user volume. The time “t” tracks the chronological lifespan of the thread from an initial instantiation to an eventual deletion.

The process begins with the ephemeral thread creation 802. During the ephemeral thread creation 802, a transient communication instance can be instantiated, optionally utilizing the ephemeral context handle. The ephemeral thread creation 802 operation can enable creating a conversation thread associated with a context handle. Following instantiation, the system captures the user interactions 804. The user interactions 804 include the collection of engagement data, such as messages, reactions, upvotes, and reply depth. Gathering the user interactions 804 can enable receiving participant messages.

The collected data feeds into the resonance scoring 806. The resonance scoring 806 performs mathematical calculations to quantify the quality and volume of the engagement. By continuously updating these metrics, the resonance scoring 806 can enable calculating resonance scores based on engagement metrics. High resonance values generated by the resonance scoring 806 drive the activity graph upward to a peak activity point. Reaching this peak activity point can trigger algorithms that elevate the visibility of the discussion within a user interface. This operational phase can enable promoting messages with higher resonance scores.

As user participation naturally tapers off, the thread enters the decay curve 808, which corresponds to the decay portion of the graphical overlay. The decay curve 808 executes an algorithmic decay of a vitality associated with the thread. Temporal decay functions, such as an exponential or linear decay mathematical operation, actively pull the computed activity score down as new interactions become scarce.

The decaying activity score can be continuously monitored against a retirement threshold. When the mathematically calculated activity drops below the retirement threshold, the retirement trigger 810 is activated. The retirement trigger 810 functions as a threshold check that initiates a final lifecycle phase of the thread. Activation of the retirement trigger 810 routes the process to the thread archival/purge 812. The thread archival/purge 812 executes data management operations that involve anonymization, cryptographic deletion, or purging of the raw text to prevent unwanted traceability or data buildup. The operations of the retirement trigger 810 and the thread archival/purge 812 can collectively enable automatically retiring or deleting the thread when engagement falls below a threshold or time limit.

In an example scenario, a user executes the ephemeral thread creation 802 to start a discussion regarding the politics of artificial intelligence. Multiple users join this newly formed space using temporary context handles, generating numerous user interactions 804 such as detailed replies and upvotes. The resonance scoring 806 calculates a high engagement depth from these interactions, pushing a graphical plot of the thread to the peak activity point. After several hours, active participation drops, and the mathematical function of the decay curve 808 initiates the decay portion of the lifecycle, progressively lowering an activity score associated with the thread. Once the activity score falls below the retirement threshold, the trigger point can be reached, and the retirement trigger 810 activates. This sends the thread to the thread archival/purge 812, permanently deleting a chat history from an active database while potentially preserving abstract, de-identified compatibility signals for the participating users.

The ephemeral thread/resonance weighting lifecycle 800 provides significant technical advantages, particularly regarding memory utilization and database optimization. By automatically identifying and purging stale data arrays via the retirement trigger 810, a hosting computing system prevents the indefinite accumulation of unstructured text data. This automatic pruning process can reduce cloud storage costs and can optimize query latencies for active database tables, as the system does not waste processing power indexing abandoned conversations. Additionally, self-expiring data provides robust security and privacy advantages by minimizing an attack surface and ensuring that transient social interactions do not become permanent, searchable records.

In some examples, the operations of the decay curve 808 and the retirement trigger 810 could utilize a strict, hardcoded time-to-live expiration, such as automatically deleting all threads exactly 24 hours after creation, rather than employing a dynamic, resonance-based decay function. This hardcoded time-to-live alternative can improve computational simplicity and can reduce continuous background processing overhead, as the system would not need to constantly recalculate activity metrics.

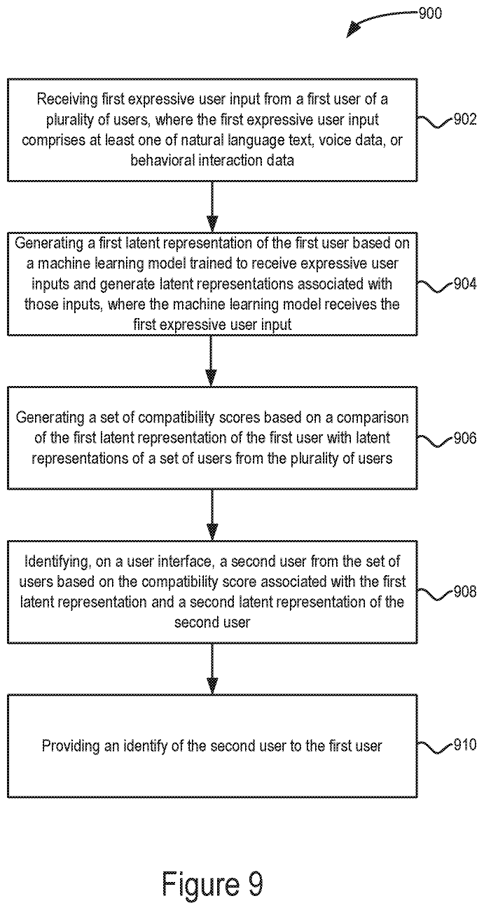

FIG. 9 illustrates a flowchart of an example process 900 for compatibility identification, detailing the chronological execution of operations by at least one computing device. FIG. 9 represents a computer-implemented process 900 that operationalizes system architectures described herein. This figure details a chronological algorithmic pipeline executed by at least one processing device to ingest data, model identity, compute compatibility, and output a controlled result.

The process 900 can be executed by at least one processing device and a memory. The chronological execution of the process 900 provides technical advantages. For example, generating latent representations prior to executing mathematical comparisons improves computational efficiency and reduces processing latency. This algorithmic structure can allow the system to execute mathematical vector operations, like cosine similarity, instead of performing computationally expensive, real-time natural language comparisons on raw text.

The process 900 at step 902 can enable receiving first expressive user input from a first user of a plurality of users, where the first expressive user input includes at least one of natural language text, voice data, or behavioral interaction data. The expressive user input can encompass information intentionally or passively communicated, such as typed text, audio recordings, interaction timing, or clickstream sequences. At least one example of this process stage has been discussed herein in relation to FIGS. 1-8.

Following the step 902, the process 900 proceeds to a step 904. The step 904 can enable generating a first latent representation of the first user based on a machine learning model trained to receive expressive user inputs and generate latent representations associated with those inputs, where the machine learning model receives the first expressive user input. During the step 904, the machine learning model receives the raw or normalized input and outputs a high-dimensional feature space or a structured schema. The first latent representation can be a dynamic, multi-dimensional vector that encodes semantic, emotional, and behavioral dimensions extracted from the expressive user input without relying solely on static, checkbox-based profile configurations. At least one example of this process stage has been discussed herein in relation to FIGS. 1-8.

Subsequent to generating the representation, the process 900 advances to a step 906. The step 906 can enable generating a set of compatibility scores based on a comparison of the first latent representation of the first user with latent representations of a set of users from the plurality of users. Within the step 906, the generation of the set of compatibility scores can incorporate evaluating semantic resonance using mathematical comparisons. For example, the at least one processing device can compute vector cosine similarity or graph distance between the first latent representation and the stored latent representations of the set of users. This operation avoids rigid attribute matching and instead evaluates structural alignment in interaction style and sentiment expression. At least one example of this process stage has been discussed herein in relation to FIGS. 1-8.

After computing the metrics, the process 900 moves to a step 908. The step 908 can enable identifying, on a user interface, a second user from the set of users based on the compatibility score associated with the first latent representation and a second latent representation of the second user. In executing the step 908, the system filters and evaluates the set of compatibility scores to isolate highly resonant connections. The identification can be presented or filtered on the user interface based on the highest compatibility scores, determining which candidate from the set of users presents the most significant thematic or emotional alignment with the first user. At least one example of this process stage has been discussed herein in relation to FIGS. 1-8.

The process 900 also includes a step 910, which can enable providing an identity of the second user to the first user. This provision of identity operates under a privacy state machine that governs visibility. Instead of exposing a verified legal identity, the step 910 can provide an ephemeral context handle or a platform-assigned handle, structurally ensuring that data disclosure can be progressive and secure. At least one example of this process stage has been discussed herein in relation to FIGS. 1-8.

In some example scenarios, a first user speaks into their user device, executing the step 902 to capture voice data. During the step 904, a processing device applies a multi-modal machine learning model, such as a transformer model, to generate a dense vector embedding representing an emotional tone and philosophical depth of the first user. The processing device executes the step 906 by computing a cosine similarity between this dense vector and a database of other vectors associated with other users. Upon executing the step 908, the system identifies a highly resonant second user based on a top-ranked compatibility score. In the step 910, the system pushes a notification to a user interface of the first user, securely providing an ephemeral handle of the second user while preserving privacy protocols.

An AI-assisted conversation facilitation and icebreaker prompt system can enhance user engagement by dynamically generating personalized conversation starters based on compatibility insights, user preferences, and real-time conversation flow. Instead of relying on users to initiate conversations awkwardly, this system can provide context-aware, interest-driven icebreakers that help establish rapport and encourage meaningful interaction. This feature can be designed to eliminate generic, repetitive opening lines by tailoring conversation prompts to each match, enhance engagement by suggesting topics that align with shared interests and personality traits, dynamically adjust conversation recommendations based on real-time user interaction, and reduce conversational friction, particularly in first-time interactions.

In a pre-conversation setup phase, the system 106 can generate personalized icebreaker prompts based on match compatibility. Before a match engages in conversation, the system 106 can analyze both users'personality traits, interests, and shared values to generate tailored conversation starters. These icebreaker prompts can be contextually relevant, drawing from mutual interests, personality dynamics, and past engagement behavior. For example, the system might generate prompts such as “You both love hiking—what's your favorite trail?” or “Your past matches enjoyed discussing career ambitions—want to explore that topic?”. The system might also offer pre-match prompt options like, “We noticed you and Person-X both have a passion for music. How about starting with your top three favorite bands?”

During dynamic interaction support, the system 106 can provide real-time conversation guidance to maintain engagement. The system 106 can monitor the conversation in real-time to provide adaptive suggestions based on the tone of the interaction, whether responses are short or detailed, and overall engagement levels. For example, if responses are short and awkward, the system 106 might suggest, “Try asking a playful question! Example: What's one guilty pleasure TV show you secretly love?”. If users are actively engaged in deep conversation, the system 106 can support continuity by suggesting follow-up questions.

The system 106 can also offer different icebreaker styles to match user communication preferences. Users can customize their conversation approach by selecting an icebreaker style, including humorous prompts, deep questions, scenario-based conversation starters, or casual, low-effort icebreakers. The system 106 learns from user preferences, prioritizing the styles that lead to the most successful interactions.

To prevent conversation drop-off, the system 106 can detect when a conversation is losing momentum and suggest ways to re-engage. For example, if a user hasn't responded for 12+ hours, the system 106 might suggest, “Would you like to send a lighthearted check-in? Example: ‘Hey, I just saw something that reminded me of our conversation . . . ’”. If a user appears disengaged, the system 106 can recommend shifting to a new topic.

In a continuous optimization process, the system 106 can learn from past conversations to improve future icebreakers. The system 106 analyzes user feedback and interaction history to refine future conversation prompts. For example, if a user repeatedly ignores humor-based prompts, the system 106 switches to more intellectual discussion starters. The system 106 can also provide users with post-match feedback, asking if they would like to emphasize successful approaches.

If a match shows strong engagement, the system 106 can suggest next steps to move from an icebreaker to a deeper connection. The system 106 can detect strong engagement signals, such as long responses or rapid exchanges, and suggest actions like moving to voice or video chat, suggesting a shared activity based on mutual interests, or highlighting a new discussion topic. For example, the system 106 might suggest, “You and Person-Y have been chatting consistently—want to try a fun question game to learn more about each other?”

An AI-driven progressive reveal model can transform how users interact with potential matches by gradually unveiling information in structured phases, rather than providing a full static profile upfront. This system allows for incremental discovery, encouraging meaningful engagement while reducing bias from instant visual impressions. The system 106 dynamically guides the sequence of reveals based on user interaction patterns, match compatibility analysis, and behavioral signals indicating user interest or disengagement. This approach ensures a more thoughtful, layered introduction, reinforcing deeper connections.

Initially, the system 106 generates a potential match and initiates a progressive reveal. The system 106 selects a match based on compatibility analysis and user preferences. Instead of displaying the full profile instantly, the system 106 releases information gradually in stages. The reveal sequence follows a predefined structure, but the system 106 dynamically adjusts based on engagement.

In the first stage, a context-based text introduction provides a minimal initial reveal. The first layer of information consists of a text-based descriptor rather than full bio details. For example, system 106 might present, “This person shares your love for adventure and deep discussions on philosophy. Would you like to learn more?”. The user must engage with this preview to unlock the next stage.

If the user opts to continue, the second stage involves a voice reveal before visuals, prioritizing emotional and personality cues. The system 106 unlocks a short voice clip recorded by the match. This voice reveal occurs before any images, reducing immediate bias based on appearance. The system 106 tracks user engagement with the voice interaction, assessing emotional response patterns.

In the third stage, selective profile details are unveiled based on gradual data release based on engagement. The system 106 progressively unlocks key details based on user interaction. If the user continues engagement, the system 106 releases additional profile sections; if the user expresses hesitation, the system 106 adjusts the pacing of reveals and offers alternative prompts. The system 106 continuously refines this process based on observed drop-off points.

In the final visual reveal and decision phase, if mutual interest is confirmed, the system 106 unlocks the final stage, revealing the user's photo(s). The system 106 ensures the reveal is balanced with prior engagement, preventing premature decisions based on superficial impressions. For example, if a user engages heavily in prior stages, the final reveal is accompanied by a compatibility summary. If the user hesitated, the system 106 provides additional supportive data.

During the user decision and AI learning process, the user can accept the match, decline and provide optional feedback, or request additional details. The system 106 analyzes user responses and refines future progressive reveal sequences based on which stages generated the most engagement, whether voice-first interactions increased interest, or if specific profile sections led to premature disengagement. Th system structures user engagement into guided stages reducing snap judgments, uses a voice-first introduction to prioritize emotional cues, dynamically refines the reveal process based on real-time user behavior, and uses engagement-based profile segmentation.

An AI-guided post-match feedback and continuous learning system can analyze user interactions after a match has been made, refining future matchmaking accuracy by learning from both successful and unsuccessful connections. This system actively tracks and learns from post-match engagement, ensuring that AI recommendations become increasingly precise and personalized over time. The system enables AI-driven post-match assessments, structured feedback collection, dynamic match history analysis, and real-time AI adjustments based on evolving user engagement patterns. This ensures continuous optimization of matchmaking, creating an AI-driven feedback loop that learns and adapts based on real-world social dynamics.

The system 106 monitors initial post-match interactions to track engagement patterns. After a match is made, the system 106 tracks initial engagement data, including whether the match initiated communication, response times, engagement duration, and sentiment analysis on early exchanges.

The system 106 can also request structured feedback on match quality from the user for continuous learning. After a set period, the system 106 prompts users for structured feedback on the match, such as rating the engagement experience, assessing if the system 106's compatibility assessment felt accurate, and asking why a match didn't progress. If a match fails, the AI can ask if the user wants to deprioritize certain traits or update preferences.

The system 106 analyzes this feedback and adjusts future recommendations as part of a continuous learning system. The system 106 compares post-match feedback with pre-match compatibility factors to identify patterns in successful versus failed matches. For example, if a user frequently disengages from highly extroverted matches, the system 106 reduces extroverted pairings in recommendations.

Furthermore, the system 106 identifies recurring success trends and adjusts compatibility weightings. Over time, the system 106 detects which compatibility factors correlate with successful interactions, refining matchmaking logic by reinforcing successful interactions and reweighting unsuccessful match patterns.

Beyond initial introductions, the system 106 provides post-match relationship insights for ongoing matches. The system 106 monitors active, long-term connections to see how frequently users interact, whether communication patterns remain strong, and which conversation styles lead to prolonged engagement.

The system 106 also summarizes match evolution over time for user reflection. Users can access a personal match history dashboard tracking past matches, key insights on what has worked best, and changes in personal preferences over time. The system 106 continuously evolves compatibility scoring based on real-world engagement trends, uses feedback collection to influence future outcomes, provides insights to help users refine their preferences, and uses match tracking to provide a historical lens into user preferences.

A dynamic AI profiling and continuous learning system can enable the system 106 to create, refine, and evolve a user's personality, preferences, and compatibility metrics in real time. Instead of relying on static, user-defined attributes, the system actively learns from interactions, responses, and behaviors to continuously update its understanding of the user. This provides an evolving AI-generated user profile, a continuous learning framework that refines compatibility precision, and a user-guided AI system that allows for corrections and real-time adjustments. This ensures the platform remains adaptive and improves the user experience and compatibility accuracy.

During onboarding, an initial AI-generated profile creation occurs where the user answers adaptive AI-driven prompts related to personality traits, social tendencies, preferred interaction styles, and intent-based goals. The system 106 analyzes these responses and generates a preliminary personality and compatibility profile. This AI-driven adaptive personality mapping based on structured and freeform responses can be a protectable element.

The system then performs continuous refinement based on user engagement. The system 106 monitors user behavior to assess how users engage within the compatibility framework, which responses generate stronger connections, how long users engage, and the types of interactions that lead to positive outcomes. For example, if a user identifies as introverted but engages highly in group settings, the system 106 refines the profile to reflect a more balanced social tendency.

The system 106 can generate mirror moment reflections for user validation. The system 106 periodically presents summarized self-reflections to the user to confirm accuracy. If the user agrees, the system 106 reinforces the profile attribute; if the user disagrees, the system 106 adjusts and refines future modeling.

The system 106 can adjust compatibility metrics in real time. Instead of using static scores, the system dynamically adjusts preferences based on behavioral data trends, user feedback, and changes in user-defined preferences. For example, if a user repeatedly declines invitations from “adventurous” personalities, those traits are deprioritized, thereby providing real-time adaptive compatibility metrics based on user engagement.

The system 106 uses past data to improve user compatibility metrics by storing and analyzing past interactions to refine future recommendations. The system 106 tracks successful interactions, identifies patterns in unstated user preferences, and updates social compatibility indicators based on past connections.

Through behavioral pattern recognition, the system 106 adapts personality and preference metrics over time. The system 106 compares a user's past interactions with their stated preferences to identify mismatches or evolving tendencies. The system 106 prompts users for confirmation before making major adjustments, ensuring the system remains transparent and user-controlled. This AI-driven comparative analysis of stated versus observed preferences with user-guided refinements can be a protectable element.

The system enables user-guided profile adjustments for transparency and accuracy. Users can review AI-driven personality updates and choose to accept, reject, or request further refinement of the system 106 assessment. Example UI elements include live-updating personality meters, a change history log, and user override options.

Users can also override system 106 decisions and manually adjust preferences. While system 106 adapts dynamically, users always have manual control to adjust intent categories, refine preference sliders, and provide direct feedback on system 106 accuracy. The system 106 learns from manual overrides and integrates them into its learning process.

The system 106 identifies and learns from longitudinal personality shifts, recognizing long-term changes in a user's personality and preferences over time. For example, if a user shifts from career-focused to prioritizing relationships, the system 106 gradually shifts compatibility priorities. The system 106 dynamically refines user profiles in real time, uses mirror moments for an interactive validation loop, dynamically shifts compatibility scoring based on engagement patterns, and uses past behavior trends to improve accuracy.

A hybrid matching system can uniquely blend AI-driven recommendations with user-directed browsing, allowing users to receive AI-curated match suggestions, manually browse and select potential matches, and provide structured feedback to refine the system 106 precision. This hybrid approach allows for a balance between guided discovery and user autonomy.

The system 106 uses AI-driven matchmaking to generate curated match recommendations based on user personality profiles, past match interactions, and real-time preference adjustments. The system 106 provides pre-match insights, displaying key compatibility traits, shared interests, and an AI-generated summary explaining why the match was selected.

The system 106 uses a progressive reveal of AI matches where matches are unveiled in stages. The system 106 presents initial contextual information before revealing full details, and users interact gradually, choosing to unlock additional information as interest develops.

Users also have a user-controlled manual browsing option. Users can search for potential matches manually instead of, or in addition to, relying on AI recommendations. Searches can be filtered by intent, shared interests, or recent engagement. The AI analyzes browsing behavior to refine future recommendations.

When users manually select a match, the system 106 provides insights on user-selected matches. The system 106 provides additional compatibility insights, such as areas of alignment versus potential friction, predictive analysis of interaction success likelihood, and suggested conversation prompts.

Users can provide structured feedback on both AI-recommended matches and user-selected matches. The system 106 adjusts matchmaking models based on these feedback loops, reinforcing existing models with positive outcomes and shifting match criteria based on negative feedback.

Once a match is mutually accepted, users proceed with a final match confirmation and interaction initiation facilitated by AI-generated conversation starters. The system 106 continues monitoring post-match interactions to refine future recommendations. The system 106 combines AI-driven matching with user autonomy, uses user browsing behavior to inform AI learning, generates insights on user-selected matches, and dynamically adjusts recommendations based on user feedback.

An intent-based social fluidity system can enable users to seamlessly transition between different types of social interactions, such as dating, friendship, study groups, or networking, based on AI-driven real-time insights, evolving user intent, and behavioral adjustments rather than relying on static, pre-set categories.

Upon signup, a user selects an initial intent from categories like social connection, study and academic networking, or dating and relationship exploration. The user can select multiple categories or refine them later.

As the user engages, the system 106 dynamically assesses user engagement and adjusts intent over time. The system 106 tracks interactions to detect shifts in intent, monitoring how the user responds to different match types and if their stated intent aligns with actual engagement patterns. The system 106 periodically prompts the user, suggesting intent adjustments.

The user retains control to adjust or override system 106 suggestions. Users can manually toggle between different intent modes at any time, while the system 106 offers suggested refinements based on user history.

The system 106 integrates social fluidity into matchmaking and user interactions by generating recommendations that span multiple intent categories when relevant. For example, study partners might receive a suggestion for a social meet-up if the system 106 detects shared social interests.

Post-match feedback enables further refinement. Users provide feedback on interactions, and the system 106 continuously refines their category weighting based on successful versus unsuccessful matches, time spent engaging, and user feedback on match relevance. The system 106 dynamically evolves based on real-time engagement instead of rigid categories, blends multiple categories in a structured way, and actively learns and adapts to human behavior.

The intent-based social fluidity system allows users to seamlessly shift between different social intentions without needing separate profiles or matchmaking processes. It provides a flexible, multi-intent user experience, dynamic AI-driven matchmaking adjustments, and a structured framework for fluid social interactions.

Users set an initial social intent but can adjust fluidly in real-time. Upon joining, users select an initial intent from categories like romantic/dating, friendship and socializing, study and academic collaboration, or networking and professional growth. Users can modify their intent at any time, keep multiple intents active, or allow the system 106 to suggest intent shifts.

The system 106 recommends matches based on user intent but tracks fluidity for adaptive social matching. The system 106 generates initial matches based on selected intent but monitors shifts in engagement behavior, suggesting adjustments if, for example, a study partner interaction becomes more personal.

Users can adjust intent per match and provide real-time feedback. Instead of a global intent, users can modify intent on a per-match basis, and the system 106 learns from these adjustments to refine future matchmaking.

The system 106 tracks intent shifts and suggests future adjustments for continuous intent optimization. The system 106 analyzes past intent changes to improve match recommendations and suggests customized user settings based on these patterns.

Compatibility insights reflect intent fluidity through a Venn diagram and adaptive matching display. Instead of rigid categories, compatibility overlays visually display areas where users may connect on multiple levels, allowing the user to prioritize one intent or allow organic interaction.

The system 106 suggests conversation prompts and activities based on intent evolution to provide guided social progression. As interactions progress, the system 106 generates icebreakers and recommends activities that align with shifting social intent. This system 106 uses AI monitoring to suggest intent shifts, features a multi-intent structure, and tracks intent shifts over time to improve precision.

A mirror moment AI reflection system can analyze user responses, interactions, and engagement patterns to create self-awareness reflections that provide users with a deeper understanding of themselves. This confirms the system 106 understanding of the user and provides the user with insights into their own behavior and preferences. The system 106 mirrors back a synthesized version of their engagement data, allowing them to refine their self-perception and enhance future interactions.

First, the system 106 collects data from user interactions. The system 106 analyzes all past user responses, engagement data, and behavioral trends, including personality assessment answers, conversations, types of users engaged with, and preferred traits.

Next, the system 106 generates a personalized mirror moment reflection. The system 106 synthesizes the collected data and presents the user with a self-reflective summary, highlighting key patterns and traits that may not have been obvious to the user.

The user then provides feedback to validate or adjust the system 106 reflection. Users confirm, reject, or modify the system 106 understanding, and the system 106 adjusts its profile modeling accordingly. If the user disagrees, the system 106 asks clarifying questions to refine accuracy.

The system 106 adjusts compatibility and future matchmaking based on insights. If the user confirms the reflection, the AI reinforces that understanding; if the user disagrees, the system 106 makes real-time adjustments and suggests different interactions.

The mirror moment becomes a recurring system 106 feature. The system 106 periodically re-engages users with new self-reflective insights to ensure user profiles remain dynamic and evolve with the person over time. The system 106 proactively validates its own understanding, it creates an interactive self-awareness model, and it features adaptive matchmaking refinements.

A personality-based AI interaction flow can dynamically adjust the tone, style, and structure of AI-driven conversations based on a user's individual personality traits, communication style, and engagement preferences. This system 106 ensures that each user's experience is uniquely tailored, enhancing engagement, self-reflection, and match quality.

Initially, the system 106 establishes a personality profile through initial interactions to form a baseline understanding. The system 106 collects structured and freeform responses during onboarding and analyzes conversational tendencies, engagement preferences, and interaction style indicators. The system 106 categorizes users into dynamic, fluid personality clusters.

The system 106 then adapts its communication style to match user personality, forming a personalized interaction framework. The system 106 adjusts its tone, depth of engagement, and conversational pacing based on the established profile. For example, a highly analytical user receives structured insights, while a playful user experiences a lighthearted interaction.

The system 106 personalizes matchmaking conversations based on user interaction patterns. The system 106 applies personality-based adjustments to matchmaking discussions so compatibility insights are framed in a way the user will best engage with.

The system 106 adapts its questioning style for self-reflection and mirror moment adjustments. When asking reflection-based questions, the system 106 customizes phrasing and framing to match user communication tendencies.

The system 106 evolves its interaction flow over time based on engagement patterns through continuous learning and refinement. The system 106 tracks user responses to assess which interaction styles yield the highest engagement and best outcomes, fine-tuning its strategies over time.

The system 106 adjusts to social context for different interaction modes, shifting its engagement approach depending on the user's intent (dating, study, social, etc.). For example, dating matches might encourage emotional depth, while study groups prioritize structured goal-setting. The system 106 dynamically adjusts conversation flow based on real-time engagement and personality, adapts tone and structure to individual tendencies, continuously refines itself, and enhances self-reflection and matchmaking success.

A pre-match compatibility insights system 106 can provide users with structured AI-generated summaries before they engage with a potential match. The system 106 synthesizes key compatibility factors into an interactive summary, explaining why the match was suggested, potential strengths and challenges, and providing guided conversation prompts.

The system 106 generates a compatibility summary before a profile reveal. The summary includes core compatibility traits, notable shared interests, and interaction style predictions, contextualizing the match with actual insights.

The system 106 highlights areas of strong compatibility versus potential differences, providing balanced insights. The user can review this breakdown before deciding to engage. The system 106 offers interactive engagement with compatibility insights. Users can interact with the system 106 summary before engaging with the match, using features like “Expand for more details” or “Show me conversation starters”.

The system 106 adjusts future compatibility summaries based on user feedback. Users can provide feedback on the system 106 assessment, and the system 106 refines how future summaries are generated based on these trends.

The system 106 enhances future recommendations based on pre-match engagement. The system 106 learns from how users engage with insights, such as expanding summaries if users frequently request more details.

During the final user decision and match confirmation, users can accept, reject, or request more details. The system 106 tracks match selection trends, refining future compatibility modeling. The system 106 generates structured insights before match engagement, highlights both strengths and differences, uses user interaction to dynamically influence future insights, and employs pre-match feedback loops to refine algorithms.

Real-time adjustments to compatibility metrics system can dynamically refine matchmaking probabilities based on continuous user engagement, evolving preferences, and historical interaction data. This system 106 can monitor user behavior, adjust compatibility weightings in real-time, and ensure a personalized, evolving matchmaking experience. Initially, the system 106 establishes an initial compatibility score for matches based on personality trait alignment, interest overlap, communication style compatibility, and user-selected preferences.

The system 106 monitors real-time user engagement and interaction data through a behavioral feedback loop. The system 106 tracks engagement signals like response rates, reactions to profile reveals, and frequency of feedback to assess if matches align with user behavior.

The system 106 refines compatibility weightings for future matches through continuous learning and adaptation. The system 106 identifies patterns in successful and unsuccessful interactions, adjusting weightings and providing explainable updates to the user.

Users can manually adjust compatibility preferences in response to system 106 insights. The system 106 provides match preference reports, allowing users to manually adjust priorities, provide feedback, or override AI refinements.

The system 106 introduces “soft matches” for experimentation and broader compatibility learning. The system 106 occasionally introduces profiles that don't fully meet prior weightings to test for potential chemistry and update compatibility scoring.

The system 106 continuously learns and refines global compatibility models across the platform for network-wide optimization. The system 106 aggregates insights across the platform to detect patterns in successful matches and common engagement drop-off points to refine matchmaking logic. The system 106 dynamically refines compatibility metrics in real time, proactively suggests refinements, improves insights through interaction tracking, and balances AI learning with user-guided adjustments.

A voice-first matching mechanism can introduce audio-based compatibility assessment into the matchmaking process, prioritizing voice and vocal expression as a primary factor in attraction, compatibility, and engagement. This enables an innovative discovery process, AI-driven voice analysis, a structured progressive reveal, and increased authenticity by reducing reliance on visual-based biases.

Users record and submit a voice introduction as part of their profile. During onboarding, users record a structured voice introduction that may include a greeting, a response to an AI prompt, and a freeform section.

The system 106 analyzes voice patterns to enhance compatibility matching. The system 106 evaluates tone, cadence, speaking pace, vocal warmth, and emotional expressiveness, cross-referencing these insights with personality assessments. In the voice-first matching experience, users listen to a potential match's voice introduction before seeing photos or bios. Users can then express interest and unlock details, request a voice-based response, or move on.

The system 106 can generate personalized icebreakers based on voice tone and keywords. The system 106 analyzes the content and tone of the introduction to suggest topics based on common themes, conversational styles, and emotional expressiveness.

Users can respond to matches using voice messages for initial conversations. The system 106 provides real-time voice-to-text transcriptions and conversation guidance based on tone analysis.

The system 106 refines future matches based on voice-based interaction success. The system 106 tracks which voice interactions lead to successful matches, adjusting future recommendations and learning from user feedback. The system 106 prioritizes voice as the primary compatibility filter, analyzes vocal qualities to refine compatibility, uses a progressive reveal process prioritizing personality over visual factors, and reduces text-based communication barriers.

The computing system 106 can generate a dynamic reflection visualization to transform user self-discovery and personality insights into a visually interactive experience. Unlike traditional matchmaking or personality assessments that rely on text-based results, this system provides dynamic, machine-generated graphical representations of a user's personality, values, and compatibility factors. This visualization serves as a mirror for self-reflection, helping users better understand their traits and how they relate to others. It acts as an interactive, evolving representation of personal growth and compatibility insights. Furthermore, it provides a way to visually compare personality dynamics with potential matches to enhance engagement. By using adaptive graphics, this system gamifies self-awareness and matchmaking, making the process more immersive, engaging, and intuitive.

The computing system 106 generates an initial personality visualization based on user input to create a self-discovery reflection model. The computing system 106 analyzes responses from onboarding prompts, past interactions, and user behavior to generate a graphical representation of personality and social preferences. Visualized data may include core personality traits, such as introversion versus extroversion; social interaction styles, such as spontaneous versus structured; emotional tendencies, such as analytical versus expressive; and value alignment heatmaps, such as the prioritization of career, relationships, or personal growth. Example visualization elements include a radar chart mapping personality dimensions, a Venn diagram overlaying shared traits with previous successful matches, and a dynamic personality wheel showing how traits shift based on new interactions. This generated, dynamic personality visualization system for user reflection can be a patentable element.

The computing system 106 can provide an interactive reflection interface, functioning as a dynamic self-discovery dashboard where users can explore and engage with insights. Users can interact with their reflection visualization by hovering over personality traits for deeper explanations, clicking on different segments to receive generated insights about how these traits affect compatibility, and adjusting weighting preferences, such as prioritizing emotional depth over shared hobbies. For example, if a user clicks on “Adventurous Spirit,” the computing system 106 explains how this trait influences their ideal match type and might suggest, “Your strongest trait is Deep Conversations. Would you like to match with others who prioritize deep discussions?”

The computing system 106 learns from user engagement and updates the reflection visualization over time, creating an evolutionary growth model. As users engage with matches and refine their preferences, the computing system 106 updates the visualization to reflect personality evolution, adds new data points based on meaningful interactions, and suggests areas for further self-exploration. For example, if a user initially identified as introverted but has several positive social interactions, the computing system 106 updates their social energy metric to a more balanced scale, and the visualization morphs in real-time, showing the shift in social behavior.

The computing system 106 integrates reflection visualization with matchmaking compatibility insights to create match comparison graphics. When viewing potential matches, users see a side-by-side comparison of their reflection visualization versus their match's visualization. Example visual overlays include a compatibility heatmap showing where values align, a personality trait comparison highlighting complementary strengths, and an emotion spectrum diagram illustrating communication tendencies. Example matchmaking insights might include, “You and Person-X share 80% alignment in emotional expression but differ in spontaneity. Would you like a generated conversation prompt to explore this further?”

The computing system 106 provides periodic reflection reports for self-improvement, tracking long-term personal growth. The computing system 106 periodically generates self-improvement reports, tracking changes in personality metrics over time, patterns in successful versus unsuccessful matches, and suggested focus areas for future matchmaking adjustments. Example report highlights might include, “Your openness to deep conversations has increased by 30% over the last 5 matches,” or “Your best connections have come from those who share a structured mindset. Would you like the system to prioritize this in future matches?”

Users can export or share reflection visuals for external insights, social sharing, and personal coaching. Users can download or share their generated reflection visualization to discuss insights with friends or mentors, use in self-improvement or therapy sessions, or track changes in personality evolution over months or years. The system creates a live, evolving visualization of a user's traits and social preferences, adapts the visualization dynamically based on real-world user interactions, allows users to interact with insights to deepen self-awareness and adjust matchmaking preferences, and integrates self-reflection with real-time matchmaking feedback for a seamless compatibility experience.

While compatibility scoring and visual representations exist in various forms across different industries, the specific execution of generated compatibility heat maps, personality trait overlays, and emotional spectrum diagrams in a dynamic, matchmaking-driven format appears to be novel.

Existing uses of compatibility heat maps include data visualization in general fields like website analytics, business intelligence, and dating app engagement tracking; personality psychology research, where heat maps analyze emotional responses statically; and corporate team-building tools, where HR platforms use compatibility scoring for workplace collaboration. The novelty in the present system is that the generated heat map dynamically evolves based on real-time interactions rather than a static assessment. Instead of showing generalized compatibility scores, it maps social, emotional, and lifestyle alignments dynamically within a matchmaking interface. For example, a heat map could visually highlight areas of strong alignment or misalignment, helping users quickly interpret their relational chemistry beyond just a number or percentage. A potential novel claim could be: “A generated compatibility heat map that adjusts based on user engagement history, self-reflection insights, and evolving preferences over time within a matchmaking environment”.

Existing uses of personality trait comparison include personality tests like MBTI or Big Five, which provide comparative text descriptions that are usually static and lack real-time learning, and some dating apps that provide compatibility scores without interactive graphical overlays. The novelty in the present system is that the generated comparison overlays evolve in real-time based on how users interact, refining matchmaking insights. Instead of simple text-based assessments, this feature gamifies compatibility exploration by providing a visual, interactive breakdown of strengths and potential friction points. A potential novel claim could be: “A dynamically updating generated personality trait comparison overlay within a matchmaking interface, allowing users to visualize compatibility in a structured, interactive format”.

Existing uses of emotional spectrum diagrams include psychology and therapy tools that use visual models statically, team-building tools that use color-coded spectrums to categorize communication styles, and generated sentiment analysis in customer service applications. The novelty in the present system is that instead of analyzing text sentiment or static emotional preferences, the computing system 106 tracks and adapts the emotional spectrum visualization based on real-time user engagement. This provides a novel way of mapping relational energy, conversational depth, and communication preferences. A potential novel claim could be: “A matchmaking-integrated generated emotional spectrum visualization that evolves based on user interactions, learning conversational tendencies and emotional engagement in real-time”. No mainstream dating app or matchmaking platform appears to be using a generated compatibility heat map, personality trait overlay, or emotional spectrum diagram in an evolving, real-time manner that updates dynamically based on user interactions. The key differentiator is that these visualizations evolve over time based on real-world engagement data, rather than being static compatibility scores or fixed assessments.

The computing system 106 can generate a compatibility Venn diagram or graphical overlay to provide users with a visual representation of compatibility between themselves and a potential match. Rather than relying on text-based compatibility summaries or numerical scores, this system presents a dynamic, interactive graphical interface that illustrates areas of strong alignment, such as mutual interests, personality traits, and values; areas of moderate alignment, where differences could be complementary; and areas of divergence, indicating potential challenges or mismatched preferences. This allows users to visually digest compatibility insights at a glance, making matchmaking more engaging, transparent, and interactive.

The computing system 106 processes compatibility data and generates the graphical overlay. After analyzing compatibility factors, the computing system 106 automatically translates the findings into a Venn diagram or alternative graphical visualization. The computing system 106 selects key matchmaking criteria, such as core values, personality traits, interests and hobbies, and social interaction style. Each compatibility factor is visually mapped, showing overlap indicating alignment and gaps indicating differences.

The computing system 106 assigns weighting to compatibility factors in the visualization. Compatibility isn't just binary; the computing system 106 weighs factors dynamically. Strong alignment results in larger overlapping areas, moderate alignment results in partially overlapping areas, and divergence results in clear gaps in the visualization. For example, a couple who shares deep intellectual curiosity but differs on social energy levels would have a strong overlap in “deep conversation” but a gap in “social activity preferences.”

Users can interact with the diagram for deeper insights. The graphical representation is interactive, allowing users to hover over sections to see detailed explanations of why certain traits match or diverge, click on categories to receive generated conversation prompts based on shared values or differences, and compare past matches using overlay-based trend analysis. For example, hovering over an “Adventure” category might reveal, “You and Person-X both value spontaneous travel and new experiences,” while clicking on “Communication Style” might reveal, “Person-X prefers text-based conversations, while you prefer voice calls—would you like a generated discussion prompt on this?”

The computing system 106 learns from user engagement with the diagram. The computing system 106 tracks how users interact with the graphical representation to refine future matchmaking. For example, if a user frequently explores specific compatibility areas like emotional depth, the computing system 106 prioritizes those areas in future matchmaking. If a user tends to ignore specific compatibility details, the computing system 106 simplifies the visualization for future matches.

The computing system 106 updates the graphical compatibility representation over time. As users engage with the platform and provide feedback, the computing system 106 updates compatibility visualizations dynamically. For example, if a user rejects multiple matches citing “energy level differences”, the computing system 106 highlights this more prominently in future visualizations. If a user consistently connects well with creative individuals, the computing system 106 expands the overlap in artistic compatibility for future matches.

Optionally, users can customize compatibility visualization preferences. Users may be allowed to prioritize certain traits in their visual display, such as requesting to “Show me emotional compatibility first.” The computing system 106 adjusts the weighting and structure of the visualization based on user-selected display preferences. The system provides a structured, generated graphical breakdown of compatibility, allows users to engage interactively with compatibility insights, learns from user interactions to refine matchmaking precision, and dynamically adjusts compatibility weightings based on behavioral data.

A dynamic profile display based on analysis by the computing system 106 transforms user profiles into adaptive, evolving representations that update in real time based on insights, engagement behavior, and self-reflection feedback. Instead of static, user-input profiles, this system ensures that profiles evolve dynamically, providing a more accurate, real-time representation of the user's personality, preferences, and compatibility factors; an engaging, interactive experience where users see their profiles shift based on learning; and a transparent way to showcase compatibility with potential matches through visualized alignment. This feature helps ensure that profiles remain fresh, reflective of user growth, and directly tied to the matchmaking process.

The computing system 106 generates an initial dynamic profile display upon user onboarding, creating a baseline profile. The system builds the user's profile based on user-inputted responses during onboarding, initial assessments of personality, preferences, and intent, and selected match categories such as dating, friendship, study, or networking. Profiles are structured as modular, expandable sections that change over time.

The profile updates in real-time based on learning and user engagement. The computing system 106 monitors ongoing engagement behavior to refine profile data dynamically, such as which types of matches the user engages with most, the interaction style the user prefers, and feedback the user provides on past matches and personality insights. For example, if a user initially selects “introverted,” but actively engages in social group chats, the computing system 106 adjusts profile descriptors to reflect a more nuanced social preference. If a user frequently rejects matches due to different lifestyle goals, the computing system 106 updates profile highlights to emphasize this priority.

The profile highlights key personality traits and compatibility factors visually. The profile incorporates interactive, visual components such as live-updating personality meter bars integrated with self-reflection insights, Venn diagram-style compatibility overlays when viewing potential matches, and adaptive “About Me” sections that highlight traits most relevant to matchmaking success. Example UI elements include a “Top Personality Traits” section displaying the user's highest-scoring traits determined dynamically, and a “Recently Updated” badge notifying the user when a key trait or preference has been adjusted based on engagement patterns.

Users can interact with their dynamic profile to provide feedback. Users can engage with driven profile updates through approval or modification of generated insights, direct input into evolving attributes, and toggles for “emphasized” traits, allowing users to manually prioritize or downplay certain aspects of their profile. For example, if the computing system 106 updates the “social energy” trait to reflect a moderate balance instead of highly introverted, the user can select to keep the update or prefer their profile to emphasize introversion.

The dynamic profile display integrates into the matchmaking experience. When viewing a potential match, users see side-by-side generated compatibility highlights, interactive overlays showing key personality alignments and differences, and suggested conversation starters based on the most relevant traits. For example, the UI might display, “You and Person-X both value structured planning, but Person-X leans slightly more flexible. Want a generated discussion prompt on this?” or “Your compatibility visualization suggests strong alignment in career ambition. Would you like to highlight this in your introduction?”

The computing system 106 drives profile evolution over time for long-term adaptability. The computing system 106 continuously updates the profile as the user engages with matches, adjusts preferences, and provides feedback on compatibility insights. Users receive periodic profile evolution reports, summarizing insights such as, “Your engagement suggests a growing preference for philosophical discussions. Would you like this reflected in your profile?” or “Based on your successful matches, we suggest emphasizing shared life goals in your profile.” The system dynamically updates based on real-time learning, allows users to actively engage with profile insights for manual refinements, integrates with matchmaking insights for an evolving representation, and enhances transparency and user trust with generated compatibility visualizations.

Interactive personality meter bars provide a dynamic, visual representation of a user's self-discovery process and the computing system 106's understanding of their personality traits, values, and social preferences. Instead of relying on static personality labels, this system offers real-time, interactive progress indicators that evolve based on user engagement, feedback, and refinement by the computing system 106. These meter bars function as a visual gauge of how well the computing system 106 understands the user in key personality domains, which traits are still being explored and refined, and how personality factors contribute to matchmaking success. This approach gamifies self-reflection and learning, making the process more engaging and intuitive for users.

The computing system 106 generates initial personality meter bars during onboarding to establish a baseline personality understanding. As the user engages with driven prompts, the system creates initial personality meter bars representing core traits, such as introversion versus extroversion, analytical versus creative thinking, and emotional expressiveness; social preferences, such as structured versus spontaneous, deep versus light conversation style; and relationship and compatibility indicators, such as independence versus interdependence, and risk-taking versus cautious personality. Each trait is visually represented as a meter bar, which starts with partial completion to indicate the computing system 106's current understanding.

The personality meters adjust in real-time based on learning in a dynamic refinement process. As users interact with the computing system 106 and the platform, meter bars shift dynamically based on user responses to self-reflection prompts, pattern recognition in user interactions, and feedback from previous matches and engagements. For example, if a user initially describes themselves as an introvert, but the computing system 106 detects strong social engagement patterns, the extroversion meter adjusts accordingly. If a user rejects multiple matches due to differing life goals, the computing system 106 prioritizes deeper compatibility evaluation for that trait.

Users can interact with the meter bars to provide feedback and adjust the computing system 106's perception. Users can click or tap on a meter bar to confirm the assessment, adjust the perception, or request more refinement. For example, if a user taps the “spontaneity” meter, the computing system 106 might ask, “Your responses suggest you enjoy structured planning. Does this align with your personality?” If the user disagrees, the computing system 106 adjusts the learning model and future match recommendations accordingly.

The computing system 106 uses personality meters to improve matchmaking accuracy. The computing system 106 uses the refined personality data from meter bar adjustments to improve compatibility predictions for matches, reduce mismatches based on misinterpreted personality factors, and suggest better-aligned conversation styles and interaction pacing. For example, if the computing system 106 detects a user prefers deeper emotional discussions, it prioritizes matches with similar conversation depth preferences.

The personality meter bars are integrated into compatibility insights and mirror moment reflections. Personality meters tie into compatibility visualizations so that when viewing a match, users see a side-by-side comparison of personality traits, and the computing system 106 highlights key alignments versus differences based on meter levels. Example UI displays include, “You and Person-X both score high in spontaneity—expect an adventurous connection!” or “Your personality meters show a difference in emotional expressiveness—want a generated icebreaker to navigate this?”

Users can track personality evolution over time for long-term growth tracking. Users can view a timeline of personality meter changes to track how their preferences have evolved over time, which traits have been refined by the computing system 106, and how past experiences influenced personality development. For example, a user might see a graph of their personality progression noting, “Your openness to spontaneity has increased by 20% based on your last 5 matches.” The system visually evolves over time creating an interactive user experience, allows users to actively engage to refine personality accuracy, uses real-time adjustments based on actual engagement patterns, and integrates personality visualization with compatibility analysis.

A multi-layered matchmaking dashboard is an interactive user interface that provides users with a centralized hub for matchmaking by combining driven recommendations with manual discovery and interactive engagement tools. Unlike traditional dating or social apps that rely on static profiles or swipe-based selection, this dashboard offers a structured, multi-dimensional experience that allows users to view and interact with recommended matches, manually explore potential matches through a flexible browsing system, access compatibility insights and personalized generated recommendations, adjust matchmaking preferences in real time, and track past interactions, engagement history, and evolving preferences. This multi-layered approach creates an adaptive and transparent matchmaking process, balancing intelligence with user control for a more engaging and data-rich matchmaking experience.

The dashboard features a powered match queue, or personalized match feed. Users receive a structured feed of recommended matches in a scrollable or grid-based format. Each match preview includes key compatibility indicators, generated insights explaining why the match was suggested, and interactive preview tools such as a progressive reveal system, voice snippet introductions, and personality-based conversation starters. Matches are ranked dynamically based on a confidence score in compatibility, user engagement patterns, and feedback from past successful or failed matches.

The dashboard includes a manual match browsing and discovery panel. Users can override recommendations and explore matches manually through a discovery tab, allowing for self-directed searches based on interests, intent, and personality filters; assisted match enhancement providing insights for manually selected profiles; and dynamic Venn diagrams and personality overlays to compare user-selected matches with recommended ones. This dual approach ensures users retain control over their match discovery process while still benefiting from matchmaking intelligence.

The dashboard provides compatibility insights and visualized comparisons. When viewing a match, users receive side-by-side generated compatibility insights highlighting shared strengths and potential differences, graphical overlays like Venn diagrams or compatibility bars for at-a-glance understanding, and generated predictions. Users can interact with insights through suggested conversation starters tailored to personality overlap and customizable filters to prioritize certain compatibility traits.

The dashboard allows for matchmaking preferences and dynamic adjustments. Users can continuously adjust preferences within the dashboard, including fine-tuning compatibility weightings, enabling or disabling certain matching filters, and integrating real-time learning. As users engage with settings, the computing system 106 refines its matchmaking process accordingly. For example, if a user frequently skips highly extroverted matches, the computing system 106 prompts, “Would you like to adjust your preferences to deprioritize extroverted personalities?”

The dashboard includes an engagement and match tracking panel for history and relationship insights. Users can track past match interactions, feedback on previous connections, and ongoing relationship development. The computing system 106 uses historical engagement data to refine future match predictions. For example, if a user frequently accepts matches with shared long-term goals, the computing system 106 prioritizes this compatibility in future recommendations.

The dashboard provides powered match coaching and interaction support for post-match guidance. The computing system 106 provides ongoing post-match insights, such as suggested follow-up topics based on engagement history, behavioral nudges, and feedback requests to improve future matches. Driven relationship tracking helps users better understand their compatibility patterns over time. The system integrates driven matchmaking, manual browsing, and real-time insights into a single dynamic dashboard, provides personalized explanations for matches, uses a hybrid browsing system, and tracks match history for predictive relationship insights.

A visual representation of progressive reveal system introduces a structured, step-by-step user interface design that gradually unveils a match's profile in phases, instead of displaying all information at once. Unlike traditional profile-based or swipe-based matchmaking apps, this system ensures that users engage with key aspects of compatibility first, before making decisions based on visual appearance or other secondary factors. This progressive reveal model enhances intentional engagement by focusing on meaningful compatibility before surface-level attributes, provides a gamified, interactive matching experience that keeps users engaged, and creates a structured decision-making process, reducing impulsive rejections based solely on appearance. By integrating dynamic visual elements, this system reimagines how users interact with potential matches, emphasizing depth and compatibility first.

In the initial stage, a generated compatibility preview provides the first layer of reveal. Users see a blurred or semi-transparent preview of a potential match's profile, along with generated compatibility insights, a brief, text-based personality introduction without names or photos, and a “compatibility readiness meter” showing confidence in the match. Example UI elements include a soft-focus effect over profile details, revealing only partial information, and dynamic generated preview cards displaying shared traits.

In the second stage, users unlock personality and interests, forming the second layer of reveal. After showing initial interest, such as by tapping “Learn More,” users unlock expanded personality traits and interest categories, a voice introduction or text bio allowing deeper engagement before visuals, and a Venn diagram visualization highlighting overlapping interests. This phase keeps profile photos hidden, ensuring users engage with personality before appearance.

In the third stage, a partial image and key match indicators build anticipation in stages. Users see a partial image reveal, such as a silhouette, blurred photo, or cropped section, key lifestyle indicators, such as work-life balance or preferred social activities, and a “mutual compatibility reflection” indicator, showing how past users with similar traits have connected. This builds anticipation while maintaining engagement through interactive elements.

In the final stage, a full profile reveal and decision phase completes the final layer of reveal. Once both users express sustained interest, the system fully reveals profile images and additional details. The computing system 106 suggests a conversation starter based on prior revealed traits and a match alignment score summarizing compatibility findings. Users now decide whether to send a match request or explore another profile.

Optionally, users can personalize their reveal preferences, allowing for user-controlled reveal timing. Users can modify how progressive reveal works based on their preferences, opting for a faster reveal for users who prefer quick matching, or a slower, engagement-driven reveal for those prioritizing deep compatibility. The computing system 106 analyzes user engagement patterns and suggests the ideal reveal pacing. The system prioritizes personality insights before full image reveals, uses generated compatibility previews to create structured engagement, employs a multi-step reveal format to prevent instant rejections, and allows customizable pacing.

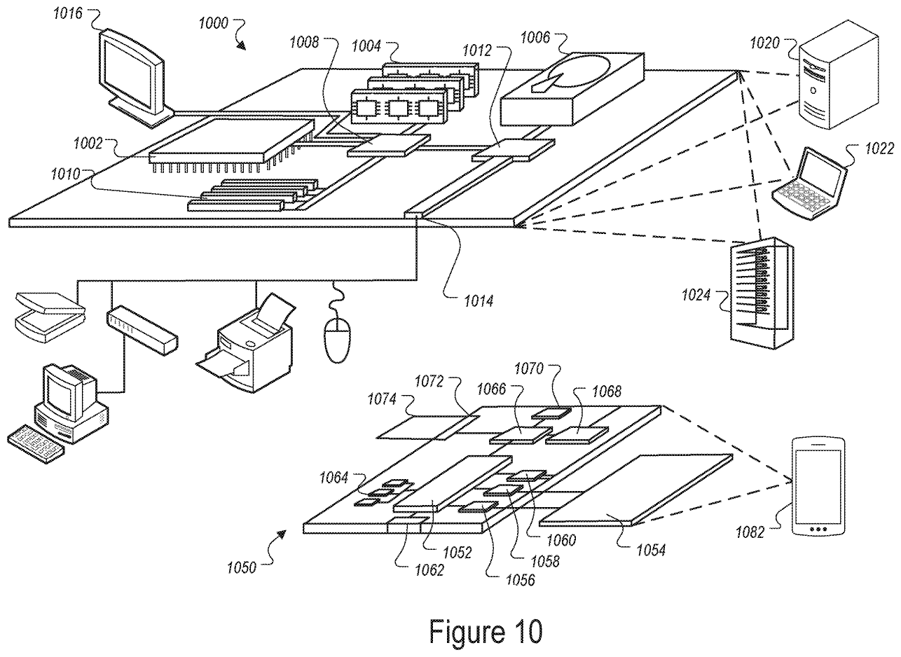

FIG. 10 is a block diagram illustrating an example computer system or device 1000 that can be used in connection with methods and processes described in this specification. For example, computing devices 1000, 1050 may be used to implement the systems and methods described in this document, either as a client or as a server or plurality of servers. More specifically, various “modules,” “engines,” “layers,” and the like can be implemented, at least in part, in software or machine code, which can be implemented for and be executed on the computing system 1000.

In some implementations, system 1000 is an example hardware computing system for implementing one or more aspects of the expressive data representation, the representation generation engine, the privacy state machine, the compatibility computation engine, the surfacing/discovery layer, tokenization engine, diarization engine sentiment/behavioral feature extraction engine, the unified normalized expressive buffer, the schema parser, the indicator mapper, the direct LLM/embedding generator, the mirror moment generation engine, the calibration engine, the expressive validation and calibration loop, the privacy state machine, the intent overlay engine, the filter trait relevance block, the wight feature clusters generation block, implicit intent detection, the user interface, the compatibility engine, the controlled surfacing/discovery layer, ephemeral thread creation, user interactions monitor, the resonance scoring block, the decay curve block, the retirement trigger and the thread archival/purge block. In some examples, the process 900 discussed in relation to FIG. 9 can be implemented and/or executed using system 1000.

In the example of FIG. 10 computing device 1000 is intended to represent various forms of digital computers, such as laptops, desktops, workstations, personal digital assistants, servers, blade servers, mainframes, and other appropriate computers. Computing device 1050 is intended to represent various forms of mobile devices, such as personal digital assistants, cellular telephones, smartphones, smartwatches, head-worn devices, and other similar computing devices. The components shown here, their connections and relationships, and their functions, are meant to be exemplary only, and are not meant to limit implementations described and/or claimed in this document.

Computing device 1000 includes a processor 1002, memory 1004, a storage device 1006, a high-speed interface 1008 connecting to memory 1004 and high-speed expansion ports 1010, and a low-speed interface 1012 connecting to low-speed bus 1014 and storage device 1006. Each of the components 1002, 1004, 1006, 1008, 1010, and 1012, are interconnected using various busses, and may be mounted on a common motherboard or in other manners as appropriate.

The processor 1002 can process instructions for execution within the computing device 1000, including instructions stored in the memory 1004 or on the storage device 1006 to display graphical information for a GUI on an external input/output device, such as display 1016 coupled to high-speed interface 1008. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1004 stores information within the computing device 1000. In one implementation, the memory 1004 is a computer-readable medium. In one implementation, the memory 1004 is a volatile memory unit or units. In another implementation, the memory 1004 is a non-volatile memory unit or units.

The storage device 1006 is capable of providing mass storage for the computing device 1000. In one implementation, the storage device 1006 is a computer-readable medium. In various different implementations, the storage device 1006 may be a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer-or machine-readable medium, such as the memory 1004, the storage device 1006, or memory on processor 1002.

The high-speed controller 1008 manages bandwidth-intensive operations for the computing device 1000, while the low-speed controller 1012 manages lower bandwidth-intensive operations. Such allocation of duties is exemplary only. In one implementation, the high-speed controller 1008 is coupled to memory 1004, display 1016 (e.g., through a graphics processor or accelerator), and to high-speed expansion ports 1010, which may accept various expansion cards (not shown). In the implementation, low-speed controller 1012 is coupled to storage device 1006 and low-speed expansion port 1014. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1020, or multiple times in a group of such servers. It may also be implemented as part of a rack server system 1024. In addition, it may be implemented in a personal computer such as a laptop computer 1022. Alternatively, components from computing device 1000 may be combined with other components in a mobile device (not shown), such as device 1050. Each of such devices may contain one or more of computing device 1000, 1050, and an entire system may be made up of multiple computing devices 1000, 1050 communicating with each other.

Computing device 1050 includes a processor 1052, memory 1064, an input/output device such as a display 1054, a communication interface 1066, and a transceiver 1068, among other components. The device 1050 may also be provided with a storage device, such as a microdrive or other device, to provide additional storage. Each of the components 1050, 1052, 1064, 1054, 1066, and 1068, are interconnected using various buses, and several of the components may be mounted on a common motherboard or in other manners as appropriate.

The processor 1052 can process instructions for execution within the computing device 1050, including instructions stored in the memory 1064. The processor may also include separate analog and digital processors. The processor may provide, for example, for coordination of the other components of the device 1050, such as control of user interfaces, applications run by device 1050, and wireless communication by device 1050.

Processor 1052 may communicate with a user through control interface 1058 and display interface 1056 coupled to a display 1054. The display 1054 may be, for example, a TFT LCD display or an OLED display, or other appropriate display technology. The display interface 1056 may comprise appropriate circuitry for driving the display 1054 to present graphical and other information to a user. The control interface 1058 may receive commands from a user and convert them for submission to the processor 1052. In addition, an external interface 1062 may be provided in communication with processor 1052, so as to enable near area communication of device 1050 with other devices. External interface 1062 may provide, for example, for wired communication (e.g., via a docking procedure) or for wireless communication (e.g., via Bluetooth or other such technologies).

The memory 1064 stores information within the computing device 1050. In one implementation, the memory 1064 is a computer-readable medium. In one implementation, the memory 1064 is a volatile memory unit or units. In another implementation, the memory 1064 is a non-volatile memory unit or units. Expansion memory 1074 may also be provided and connected to device 1050 through expansion interface 1072, which may include, for example, a SIMM card interface. Such expansion memory 1074 may provide extra storage space for device 1050, or may also store applications or other information for device 1050.

Specifically, expansion memory 1074 may include instructions to carry out or supplement the processes described above, and may include secure information also. Thus, for example, expansion memory 1074 may be provided as a security module for device 1050, and may be programmed with instructions that permit secure use of device 1050. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 1064, expansion memory 1074, or memory on processor 1052.

Device 1050 may communicate wirelessly through communication interface 1066, which may include digital signal processing circuitry where necessary. Communication interface 1066 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1068. In addition, short-range communication may occur, such as using a Bluetooth, WiFi, or other such transceiver (not shown). In addition, GPS receiver module 1070 may provide additional wireless data to device 1050, which may be used as appropriate by applications running on device 1050.

Device 1050 may also communicate audibly using audio codec 1060, which may receive spoken information from a user and convert it to usable digital information. Audio codec 1060 may likewise generate audible sound for a user, such as through a speaker, e.g., in a handset of device 1050. Such sound may include sound from voice telephone calls, may include recorded sound (e.g., voice messages, music files, etc.) and may also include sound generated by applications operating on device 1050.

The computing device 1050 may be implemented in a number of different forms, as shown in the figure. For example, it may be implemented as a cellular telephone 1080. It may also be implemented as part of a smartphone 1082, personal digital assistant, or other similar mobile device.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “computing system” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment.

A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array), an ASIC (application specific integrated circuit), or a GPGPU (General purpose graphics processing unit).

Computers suitable for the execution of a computer program include, by way of example, can be based on general or special purpose microprocessors or both, or any other kind of central processing unit. Generally, a central processing unit will receive instructions and data from a read only memory or a random-access memory or both. Some elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving, by at least one processing device, first expressive user input from a first user of a plurality of users, wherein the first expressive user input comprises at least one of natural language text, voice data, or behavioral interaction data;
generating, by the at least one processing device, a first latent representation of the first user based on a machine learning model trained to receive expressive user inputs and generate latent representations associated with those inputs, wherein the machine learning model receives the first expressive user input;
generating, by the at least one processing device, a set of compatibility scores based on a comparison of the first latent representation of the first user with latent representations of a set of users from the plurality of users;
identifying, by the at least one processing device on a user interface, a second user from the set of users based on the compatibility score associated with the first latent representation and a second latent representation of the second user; and
providing, by the at least one processing device, an identity of the second user to the first user.

2. The computer-implemented method of claim 1, wherein the machine learning model is a multi-modal machine learning model.

3. The computer-implemented method of claim 1, wherein the set of compatibility scores is generated based on vector similarity of graph distance between the first latent representation and latent representations of the set of users.

4. The computer-implemented method of claim 1, comprising determining, by the at least one processing device, a currently active state of the first user, and based on the currently active state, cryptographically restrict access to an identity of the first user.

5. The computer-implemented method of claim 4, wherein the current active state of the first user is one of a verified legal identity state, a platform-assigned handle state, and an ephemeral context handle state.

6. The computer-implemented method of claim 5, comprising:
transitioning, by the at least one processing device, the currently active state from the verified legal identity state to the platform assigned handle state based on user consent.

7. The computer-implemented method of claim 5, comprising:
transitioning, by the at least one processing device, the currently active state from the ephemeral context handle state to the verified legal identity state based on at least one of a contextual change or a timeout.

8. The computer-implemented method of claim 5, comprising:
storing, by the at least one processing device, first user data under a verified legal identity;
generating, by the at least one processing device, a platform-assigned handle; and
generating, by the at least one processing device, at least one ephemeral context handle for session-specific interactions.

9. The computer-implemented method of claim 1, comprising:
receiving, by the at least one processing device, feedback from the first user on a presented interpretive reflection; and
updating, by the at least one processing device, the first latent representation based on the feedback.

10. The computer-implemented method of claim 1, comprising:
determining, by the at least one processing device, a current intent domain of the first user; and
adjusting, by the at least one processing device, compatibility scores based on the current intent domain of the first user.

11. A system, comprising:
at least one storage device; and
at least one computing device, wherein instructions stored in the at least one storage device when executed on the at least one computing device cause the at least one computing device to perform operations comprising:
receiving first expressive user input from a first user of a plurality of users, wherein the first expressive user input comprises at least one of natural language text, voice data, or behavioral interaction data;
generating a first latent representation of the first user based on a machine learning model trained to receive expressive user inputs and generate latent representations associated with those inputs, wherein the machine learning model receives the first expressive user input;
generating a set of compatibility scores based on a comparison of the first latent representation of the first user with latent representations of a set of users from the plurality of users;
identifying, on a user interface, a second user from the set of users based on the compatibility score associated with the first latent representation and a second latent representation of the second user; and
providing an identify of the second user to the first user.

12. The system of claim 11, wherein the machine learning model is a multi-modal machine learning model.

13. The system of claim 11, wherein the set of compatibility scores is generated based on vector similarity of graph distance between the first latent representation and latent representations of the set of users.

14. The system of claim 11, the operations comprising determining a currently active state of the first user, and based on the currently active state, cryptographically restrict access to an identity of the first user, wherein the current active state of the first user is one of a verified legal identity state, a platform-assigned handle state, and an ephemeral context handle state.

15. The system of claim 14, the operations comprising:
transitioning the currently active state from the ephemeral context handle state to the verified legal identity state based on at least one of a contextual change or a timeout.

16. The system of claim 15, the operations comprising:
storing first user data under a verified legal identity;
generating a platform-assigned handle; and
generating at least one ephemeral context handle for session-specific interactions.

17. The system of claim 1, the operations comprising:
receiving, by the at least one processing device, feedback from the first user on a presented interpretive reflection; and
updating, by the at least one processing device, the first latent representation based on the feedback.

18. A non-transitory computer readable storage medium storing instructions that when executed by at least one processing device cause the at least one processing device to perform operations comprising:
receiving first expressive user input from a first user of a plurality of users, wherein the first expressive user input comprises at least one of natural language text, voice data, or behavioral interaction data;
generating a first latent representation of the first user based on a machine learning model trained to receive expressive user inputs and generate latent representations associated with those inputs, wherein the machine learning model receives the first expressive user input;
generating a set of compatibility scores based on a comparison of the first latent representation of the first user with latent representations of a set of users from the plurality of users;
identifying, on a user interface, a second user from the set of users based on the compatibility score associated with the first latent representation and a second latent representation of the second user;
providing an identify of the second user to the first user.

19. The non-transitory computer readable storage medium of claim 18, the operations comprising determining a currently active state of the first user, and based on the currently active state, cryptographically restrict access to an identity of the first user, wherein the current active state of the first user is one of a verified legal identity state, a platform-assigned handle state, and an ephemeral context handle state.

20. The non-transitory computer readable storage medium of claim 18, the operations comprising:
receiving, by the at least one processing device, feedback from the first user on a presented interpretive reflection; and
updating, by the at least one processing device, the first latent representation based on the feedback.
